(19) United States
(12) Patent Application Publication
(10) Pub. No.: US 2017/0078160 A1
(43) Pub. Date: Mar. 16, 2017

(54) METHOD FOR PROCESSING SERVICES AND ELECTRONIC DEVICE FOR THE SAME

(71) Applicant: Samsung Electronics Co., Ltd, Gyeonggi-do (KR)

(72) Inventors: Jaemok Hong, Seoul (KR); Hyeonseung Kim, Gyeonggi-do (KR); Namgeol Lee, Seoul (KR)

(21) Appl. No.: 15/267,587

(22) Filed: Sep. 16, 2016

(30) Foreign Application Priority Data
Sep. 16, 2015 (KR) 10-2015-0131047

(51) Int. Cl. H04L 12/24; G06F 9/445

(52) U.S. Cl. CPC H04L 41/5041; G06F 8/65

(57) ABSTRACT

An electronic device includes a communication interface, a memory, and a processor. The memory is configured to store the reservation time to perform communication with a plurality of external devices. The processor is connected to the communication interface and the memory and configured to receive a service request from at least one of the plurality of external devices through the communication interface, determine the communication request time that is related to the service request based on the reservation time stored in the memory and the load that is related to the reservation time, and transmit the determined communication request time to at least one external device through the communication interface

### CROSS-REFERENCE TO RELATED APPLICATION(S) AND CLAIM OF PRIORITY

The present application is related to and claims the priority under 35 U.S.C. §119(a) to Korean Application Serial No. 10-2015-0131047, which was filed in the Korean Intellectual Property Office on Sep. 16, 2015, the entire content of which is hereby incorporated by reference.

### TECHNICAL FIELD

The various embodiments relate to a service request processing method and an apparatus thereof.

### BACKGROUND

Various electronic devices, such as mobile communication terminals, PDAs (Personal Digital Assistant), electronic organizers, smart phones, tablet PCs (Personal Computer), or wearable devices, have been released, which can perform communication and can process personal information while moving. Such electronic devices have adopted various functions, such as a voice call, a messaging function {e.g., SMS (Short Message Service)/MMS (Multimedia Message Service)}, a video call, an electronic organizer, a photographing function, an e-mail transmitting/receiving function, a broadcast reproducing function, the Internet, a music playing function, schedule management, a social networking service (SNS), a messenger, dictionaries, or games.

The electronic device may make a request to a sever (e.g., an application store server, a stock server, a mobile communication server, a weather server, or the like) for data at a constant time interval in order to check the state or in order to make an update. The data request may be made at a predetermined time (e.g., at 9:00 am everyday) or in a constant period (e.g., daily or weekly). The policy that is related to the data request may be configured by the electronic device or the server.

If a plurality of clients (e.g., the electronic devices) simultaneously make a request to the server for data at a predetermined time, the server may be overloaded at the predetermined time. For example, in the case where the maximum availability number of the server (e.g., the number of available clients that can access the server at one time) is 100, 150 clients may make a request to the server for data at the same time. In this case, since the number of clients that have requested the data exceeds the maximum availability number, the server may get overloaded. In order to solve this problem, a prior art has used a method in which the client makes a request to the server for data based on the booting time of the client. However, if a plurality of clients boot up at the same time, the server may get the same overload as with the case above.

### SUMMARY

To address the above-discussed deficiencies, it is a primary object to provide a method and an apparatus for determining the next update time based on the available time of the server when processing a service request of the electronic device in order to thereby disperse the server load in relation to the service request of the electronic device and in order to thereby utilize resources of the server effectively.

An electronic device, according to various embodiments, may include: a communication interface; a memory that is configured to store the reservation time to perform communication with a plurality of external devices; and a processor that is functionally connected to the communication interface and the memory, wherein the processor is configured to: receive a service request from at least one of the plurality of external devices through the communication interface; determine the communication request time that is related to the service request based on the reservation time and the load that is related to the reservation time; and transmit the determined communication request time to at least one external device through the communication interface.

An electronic device, according to various embodiments, may include: a memory that is configured to store reservation information that is related to a service request; and a processor that is functionally connected to the memory, wherein the processor is configured to: determine whether or not the reservation information is stored in the memory according to the detection of a service request event; and transmit the service request to an external device at the communication request time contained in the reservation information or at the detection time of the service request event based on the determination result.

A service processing method, according to various embodiments, may include: receiving a service request from at least one of a plurality of external devices; determining the communication request time that is related to the service request based on the reservation time stored in a memory and the load that is related to the reservation time; and transmitting the communication request time to at least one external device.

According to various embodiments, the load on the server may be dispersed by redistributing the time for processing the update that is individually requested by each of a plurality of electronic devices by means of an available time of the server.

According to various embodiments, the communication request time for each of a plurality of electronic devices may be allocated with an off-peak time of the server in order to thereby maximize the efficiency of server resources.

According to various embodiments, the communication request time may be configured based on the type of application or based on the priority of the electronic device in order to thereby secure a proper timing with respect to the request of the electronic device, which is required to be urgently processed.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an electronic device in a network environment according to various embodiments;

FIG. 2 illustrates a block diagram of an electronic device according to various embodiments;

FIG. 3 illustrates a block diagram of a program module according to various embodiments;

FIG. 4 illustrates a comparison between an embodiment of the present disclosure and the prior art;

FIG. 5 illustrates the configuration of a system for processing the update according to various embodiments;

FIG. 6 illustrates a flowchart of a method for processing the update in a client and a server according to various embodiments;

FIGS. 7A and 7B illustrate another configuration of a system for processing the update according to various embodiments;

FIG. 8 illustrates a flowchart of a method for processing the update in a client and a server according to various embodiments;

FIG. 9 illustrates a flowchart of an update processing method according to various embodiments;

FIG. 10 illustrates a flowchart of a method for processing the update in various manners according to various embodiments;

FIG. 11 illustrates an example of uniformly selecting slots according to various embodiments;

FIG. 12 illustrates an example of selecting a slot based on the priority according to various embodiments; and

FIG. 13 illustrates a flowchart of an update processing method according to various embodiments.

### DETAILED DESCRIPTION

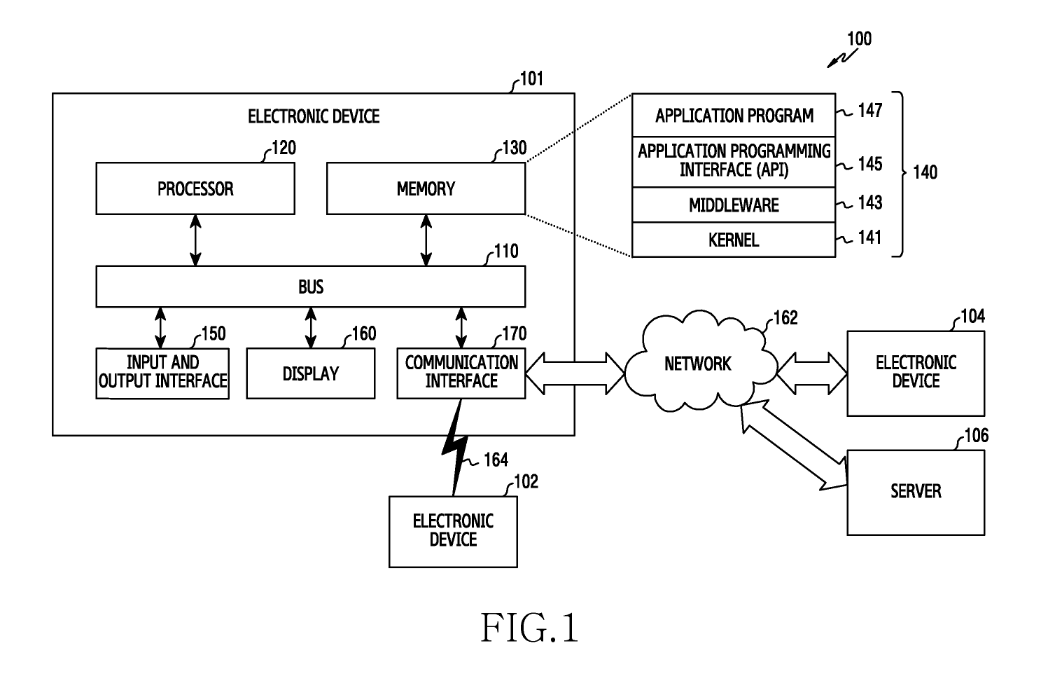

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B. The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used in the present disclosure are only used to describe specific embodiments, and are not intended to limit the present disclosure. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit).

According to some embodiments, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., SAMSUNG HOMESYNC™, APPLE TV®, or GOOGLE TV®), a game console (e.g., XBOX® and PLAYSTATION®), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MM), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

FIG. 1 illustrates a network environment including an electronic device according to various embodiments of the present disclosure.

An electronic device 101 within a network environment 100, according to various embodiments, will be described with reference to FIG. 1. The electronic device 101 may include a bus 110, a processor 120, a memory 130, an input/output interface 150, a display 160, and a communication interface 170. According to an embodiment of the present disclosure, the electronic device 101 may omit at least one of the above components or may further include other components.

The bus 110 may include, for example, a circuit which interconnects the components 110 to 170 and delivers a communication (e.g., a control message and/or data) between the components 110 to 170.

The processor 120 may include one or more of a Central Processing Unit (CPU), an Application Processor (AP), and a Communication Processor (CP). The processor 120 may carry out, for example, calculation or data processing relating to control and/or communication of at least one other component of the electronic device 101.

The memory 130 may include a volatile memory and/or a non-volatile memory. The memory 130 may store, for example, commands or data relevant to at least one other component of the electronic device 101. According to an embodiment of the present disclosure, the memory 130 may store software and/or a program 140. The program 140 may include, for example, a kernel 141, middleware 143, an Application Programming Interface (API) 145, and/or application programs (or “applications”) 147. At least some of the kernel 141, the middleware 143, and the API 145 may be referred to as an Operating System (OS).

The kernel 141 may control or manage system resources (e.g., the bus 110, the processor 120, or the memory 130) used for performing an operation or function implemented in the other programs (e.g., the middleware 143, the API 145, or the application programs 147). Furthermore, the kernel 141 may provide an interface through which the middleware 143, the API 145, or the application programs 147 may access the individual components of the electronic device 101 to control or manage the system resources.

The middleware 143, for example, may serve as an intermediary for allowing the API 145 or the application programs 147 to communicate with the kernel 141 to exchange data.

Also, the middleware 143 may process one or more task requests received from the application programs 147 according to priorities thereof. For example, the middleware 143 may assign priorities for using the system resources (e.g., the bus 110, the processor 120, the memory 130, or the like) of the electronic device 101, to at least one of the application programs 147. For example, the middleware 143 may perform scheduling or loading balancing on the one or more task requests by processing the one or more task requests according to the priorities assigned thereto.

The API 145 is an interface through which the applications 147 control functions provided from the kernel 141 or the middleware 143, and may include, for example, at least one interface or function (e.g., instruction) for file control, window control, image processing, character control, and the like.

The input/output interface 150, for example, may function as an interface that may transfer commands or data input from a user or another external device to the other element(s) of the electronic device 101. Furthermore, the input/output interface 150 may output the commands or data received from the other element(s) of the electronic device 101 to the user or another external device.

Examples of the display 160 may include a Liquid Crystal Display (LCD), a Light-Emitting Diode (LED) display, an Organic Light-Emitting Diode (OLED) display, a MicroElectroMechanical Systems (MEMS) display, and an electronic paper display. The display 160 may display, for example, various types of contents (e.g., text, images, videos, icons, or symbols) to users. The display 160 may include a touch screen, and may receive, for example, a touch, gesture, proximity, or hovering input using an electronic pen or a user's body part.

The communication interface 170 may establish communication, for example, between the electronic device 101 and an external device (e.g., a first external electronic device 102, a second external electronic device 104, or a server 106). For example, the communication interface 170 may be connected to a network 162 through wireless or wired communication, and may communicate with an external device (e.g., the second external electronic device 104 or the server 106). The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), Wireless Broadband (WiBro), and Global System for Mobile Communications (GSM), as a cellular communication protocol. In addition, the wireless communication may include, for example, short range communication 164. The short-range communication 164 may include at least one of, for example, Wi-Fi, Bluetooth, Near Field Communication (NFC), and Global Navigation Satellite System (GNSS). GNSS may include, for example, at least one of global positioning system (GPS), global navigation satellite system (GLONASS), BEIDOU Navigation satellite system (BEIDOU) or GALILEO, and the European global satellite-based navigation system, based on a location, a bandwidth, or the like. Hereinafter, in the present disclosure, the “GPS” may be interchangeably used with the “GNSS”. The wired communication may include, for example, at least one of a Universal Serial Bus (USB), a High Definition Multimedia Interface (HDMI), Recommended Standard 232 (RS-232), and a Plain Old Telephone Service (POTS). The network 162 may include at least one of a telecommunication network such as a computer network (e.g., a LAN or a WAN), the Internet, and a telephone network.

Each of the first and second external electronic devices 102 and 104 may be of a type identical to or different from that of the electronic device 101. According to an embodiment of the present disclosure, the server 106 may include a group of one or more servers. According to various embodiments of the present disclosure, all or some of the operations performed in the electronic device 101 may be executed in another electronic device or a plurality of electronic devices (e.g., the electronic devices 102 and 104 or the server 106). According to an embodiment of the present disclosure, when the electronic device 101 has to perform some functions or services automatically or in response to a request, the electronic device 101 may request another device (e.g., the electronic device 102 or 104 or the server 106) to execute at least some functions relating thereto instead of or in addition to autonomously performing the functions or services. Another electronic device (e.g., the electronic device 102 or 104, or the server 106) may execute the requested functions or the additional functions, and may deliver a result of the execution to the electronic device 101. The electronic device 101 may process the received result as it is or additionally, and may provide the requested functions or services. To this end, for example, cloud computing, distributed computing, or client-server computing technologies may be used.

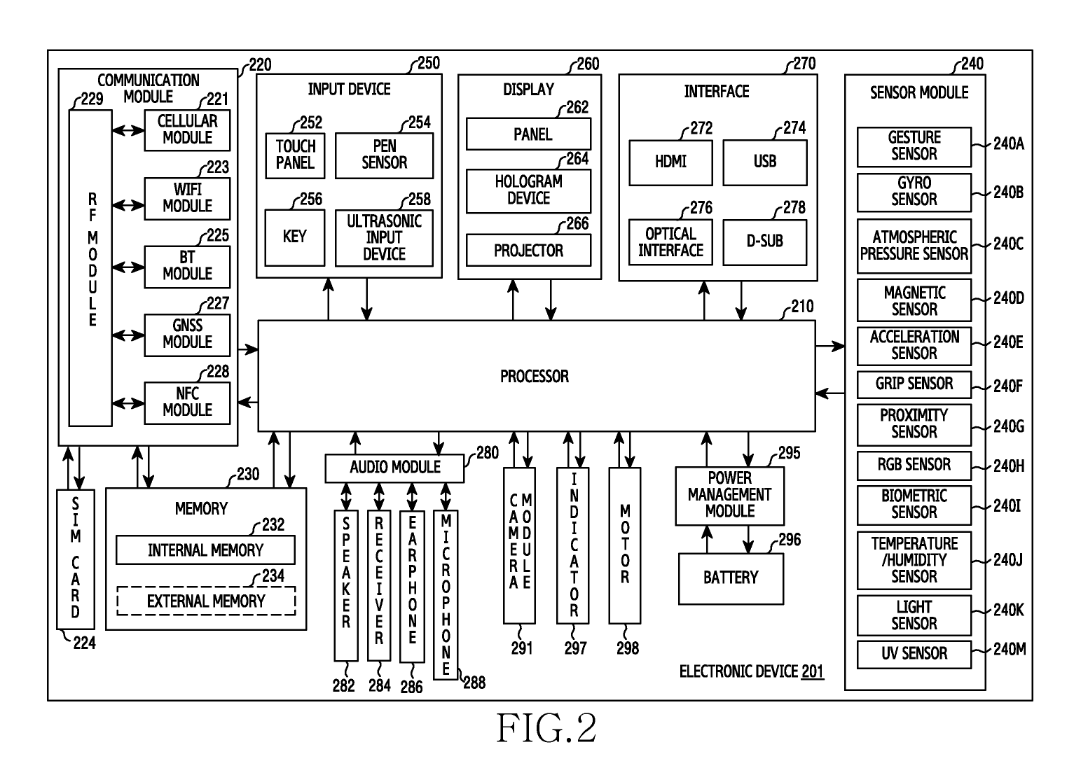

FIG. 2 illustrates a block diagram of an electronic device according to various embodiments of the present disclosure.

The electronic device 201 may include, for example, all or a part of the electronic device 101 shown in FIG. 1. The electronic device 201 may include one or more processors 210 (e.g., Application Processors (AP)), a communication module 220, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected to the processor 210 by driving an operating system or an application program, and perform processing of various pieces of data and calculations. The processor 210 may be embodied as, for example, a System on Chip (SoC). According to an embodiment of the present disclosure, the processor 210 may further include a Graphic Processing Unit (GPU) and/or an image signal processor. The processor 210 may include at least some (for example, a cellular module 221) of the components illustrated in FIG. 2. The processor 210 may load, into a volatile memory, commands or data received from at least one (e.g., a non-volatile memory) of the other components and may process the loaded commands or data, and may store various data in a non-volatile memory.

The communication module 220 may have a configuration equal or similar to that of the communication interface 170 of FIG. 1. The communication module 220 may include, for example, a cellular module 221, a WI-FI® module 223, a BT module 225, a GNSS module 227 (e.g., a GPS module 227, a GLONASS module, a BEIDOU module, or a GALILEO module), an NFC module 228, and a Radio Frequency (RF) module 229.

The cellular module 221, for example, may provide a voice call, a video call, a text message service, or an Internet service through a communication network. According to an embodiment of the present disclosure, the cellular module 221 may distinguish and authenticate the electronic device 201 in a communication network using a subscriber identification module (e.g: SIM card) 224 (for example, the SIM card). According to an embodiment of the present disclosure, the cellular module 221 may perform at least some of the functions that the AP 210 may provide. According to an embodiment of the present disclosure, the cellular module 221 may include a communication processor (CP).

For example, each of the WI-FI® module 223, the BT module 225, the GNSS module 227, and the NFC module 228 may include a processor for processing data transmitted/received through a corresponding module. According to an embodiment of the present disclosure, at least some (e.g., two or more) of the cellular module 221, the WI-FI® module 223, the BT module 225, the GNSS module 227, and the NFC module 228 may be included in one Integrated Chip (IC) or IC package.

The RF module 229, for example, may transmit/receive a communication signal (e.g., an RF signal). The RF module 229 may include, for example, a transceiver, a Power Amplifier Module (PAM), a frequency filter, a Low Noise Amplifier (LNA), and an antenna. According to another embodiment of the present disclosure, at least one of the cellular module 221, the WI-FI® module 223, the BT module 225, the GNSS module 227, and the NFC module 228 may transmit/receive an RF signal through a separate RF module.

The subscriber identification module 224 may include, for example, a card including a subscriber identity module and/or an embedded SIM, and may contain unique identification information (e.g., an Integrated Circuit Card Identifier (ICCID)) or subscriber information (e.g., an International Mobile Subscriber Identity (IMSI)).

The memory 230 (e.g., the memory 130) may include, for example, an embedded memory 232 or an external memory 234. The embedded memory 232 may include at least one of a volatile memory (e.g., a Dynamic Random Access Memory (DRAM), a Static RAM (SRAM), a Synchronous Dynamic RAM (SDRAM), and the like) and a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (e.g., a NAND flash memory or a NOR flash memory), a hard disc drive, a Solid State Drive (SSD), and the like).

The external memory 234 may further include a flash drive, for example, a Compact Flash (CF), a Secure Digital (SD), a Micro Secure Digital (Micro-SD), a Mini Secure Digital (Mini-SD), an eXtreme Digital (xD), a MultiMediaCard (MMC), a memory stick, or the like. The external memory 234 may be functionally and/or physically connected to the electronic device 201 through various interfaces.

The sensor module 240, for example, may measure a physical quantity or detect an operation state of the electronic device 201, and may convert the measured or detected information into an electrical signal. The sensor module 240 may include, for example, at least one of a gesture sensor 240A, a gyro sensor 240B, an atmospheric pressure sensor (barometer) 240C, a magnetic sensor 240D, an acceleration sensor 240E, a grip sensor 240F, a proximity sensor 240G, a color sensor 240H (e.g., red, green, and blue (RGB) sensor), a biometric sensor (medical sensor) 2401, a temperature/humidity sensor 240J, an illuminance sensor 240K, and a Ultra Violet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an Infrared (IR) sensor, an iris scan sensor, and/or a finger scan sensor. The sensor module 240 may further include a control circuit for controlling one or more sensors included therein. According to an embodiment of the present disclosure, the electronic device 201 may further include a processor configured to control the sensor module 240, as a part of the processor 210 or separately from the processor 210, and may control the sensor module 240 while the processor 210 is in a sleep state.

The input device 250 may include, for example, a touch panel 252, a (digital) pen sensor 254, a key 256, or an ultrasonic input device 258. The touch panel 252 may use, for example, at least one of a capacitive type, a resistive type, an infrared type, and an ultrasonic type. The touch panel 252 may further include a control circuit. The touch panel 252 may further include a tactile layer, and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect, through a microphone (e.g., the microphone 288), ultrasonic waves generated by an input tool, and identify data corresponding to the detected ultrasonic waves.

The display 260 (e.g., the display 160) may include a panel 262, a hologram device 264, or a projector 266. The panel 262 may include a configuration identical or similar to the display 160 illustrated in FIG. 1. The panel 262 may be implemented to be, for example, flexible, transparent, or wearable. The panel 262 may be embodied as a single module with the touch panel 252. The hologram device 264 may show a three dimensional (3D) image in the air by using an interference of light. The projector 266 may project light onto a screen to display an image. The screen may be located, for example, in the interior of or on the exterior of the electronic device 201. According to an embodiment of the present disclosure, the display 260 may further include a control circuit for controlling the panel 262, the hologram device 264, or the projector 266.

The interface 270 may include, for example, a High-Definition Multimedia Interface (HDMI) 272, a Universal Serial Bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) standard interface.

The audio module 280, for example, may bilaterally convert a sound and an electrical signal. At least some components of the audio module 280 may be included in, for example, the input/output interface 150 illustrated in FIG. 1. The audio module 280 may process voice information input or output through, for example, a speaker 282, a receiver 284, earphones 286, or the microphone 288.

The camera module 291 is, for example, a device which may photograph a still image and a video. According to an embodiment of the present disclosure, the camera module 291 may include one or more image sensors (e.g., a front sensor or a back sensor), a lens, an Image Signal Processor (ISP) or a flash (e.g., LED or xenon lamp).

The power management module 295 may manage, for example, power of the electronic device 201. According to an embodiment of the present disclosure, the power management module 295 may include a Power Management Integrated Circuit (PMIC), a charger Integrated Circuit (IC), or a battery or fuel gauge. The PMIC may use a wired and/or wireless charging method. Examples of the wireless charging method may include, for example, a magnetic resonance method, a magnetic induction method, an electromagnetic wave method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature while charging. The battery 296 may include, for example, a rechargeable battery and/or a solar battery.

The indicator 297 may display a particular state (e.g., a booting state, a message state, a charging state, or the like) of the electronic device 201 or a part (e.g., the processor 210) of the electronic device 201. The motor 298 may convert an electrical signal into a mechanical vibration, and may generate a vibration, a haptic effect, or the like. Although not illustrated, the electronic device 201 may include a processing device (e.g., a GPU) for supporting a mobile TV. The processing device for supporting a mobile TV may process, for example, media data according to a certain standard such as Digital Multimedia Broadcasting (DMB), Digital Video Broadcasting (DVB), or MEDIAFLO™.

Each of the above-described component elements of hardware according to the present disclosure may be configured with one or more components, and the names of the corresponding component elements may vary based on the type of electronic device. In various embodiments, the electronic device may include at least one of the above-described elements. Some of the above-described elements may be omitted from the electronic device, or the electronic device may further include additional elements. Also, some of the hardware components according to various embodiments may be combined into one entity, which may perform functions identical to those of the relevant components before the combination.

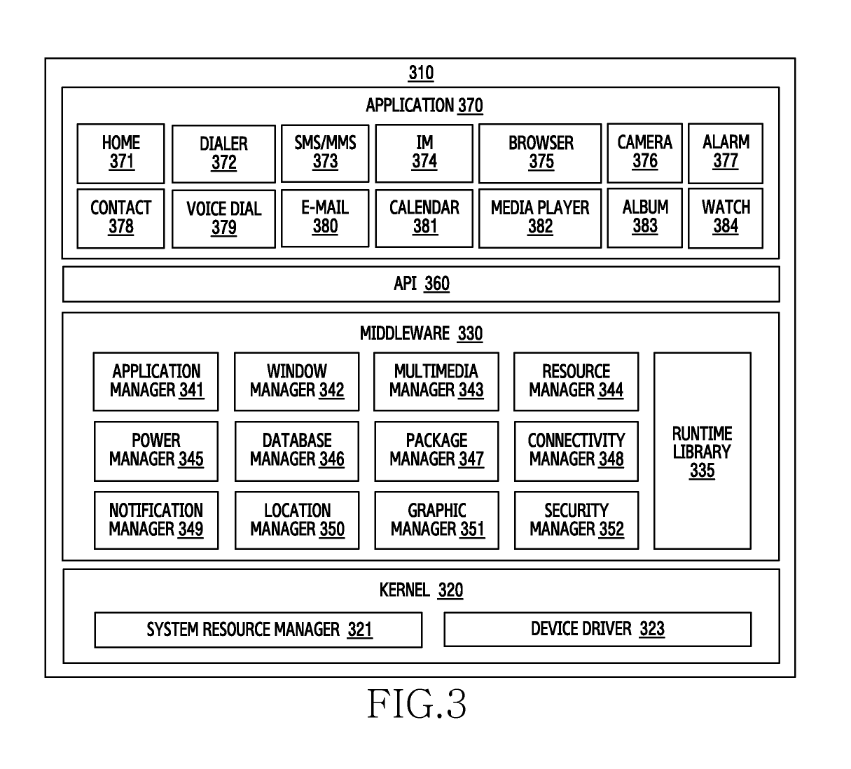

FIG. 3 illustrates a block diagram of a program module according to various embodiments of the present disclosure.

According to an embodiment of the present disclosure, the program module 310 (e.g., the program 140) may include an Operating System (OS) for controlling resources related to the electronic device (e.g., the electronic device 101) and/or various applications (e.g., the application programs 147) executed in the operating system. The operating system may be, for example, ANDROID®, iOS®, WINDOWS®, SYMBIAN®, TIZEN®, SAMSUNG BADA®, or the like.

The program module 310 may include a kernel 320, middleware 330, an API 360, and/or applications 370. At least some of the program module 310 may be preloaded on an electronic device, or may be downloaded from an external electronic device (e.g., the electronic device 102 or 104, or the server 106).

The kernel 320 (e.g., the kernel 141) may include, for example, a system resource manager 321 and/or a device driver 323. The system resource manager 321 may control, allocate, or collect system resources. According to an embodiment of the present disclosure, the system resource manager 321 may include a process management unit, a memory management unit, a file system management unit, and the like. The device driver 323 may include, for example, a display driver, a camera driver, a Bluetooth driver, a shared memory driver, a USB driver, a keypad driver, a Wi-Fi driver, an audio driver, or an Inter-Process Communication (IPC) driver.

For example, the middleware 330 may provide a function required in common by the applications 370, or may provide various functions to the applications 370 through the API 360 so as to enable the applications 370 to efficiently use the limited system resources in the electronic device. According to an embodiment of the present disclosure, the middleware 330 (e.g., the middleware 143) may include at least one of a run time library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while an application 370 is being executed. The runtime library 335 may perform input/output management, memory management, the functionality for an arithmetic function, or the like.

The application manager 341 may manage, for example, a life cycle of at least one of the applications 370. The window manager 342 may manage Graphical User Interface (GUI) resources used by a screen. The multimedia manager 343 may recognize a format required for reproduction of various media files, and may perform encoding or decoding of a media file by using a codec suitable for the corresponding format. The resource manager 344 may manage resources of a source code, a memory, and a storage space of at least one of the applications 370.

The power manager 345 may operate together with, for example, a Basic Input/Output System (BIOS) or the like to manage a battery or power source and may provide power information or the like required for the operations of the electronic device. The database manager 346 may generate, search for, and/or change a database to be used by at least one of the applications 370. The package manager 347 may manage installation or an update of an application distributed in a form of a package file.

For example, the connectivity manager 348 may manage wireless connectivity such as Wi-Fi or Bluetooth. The notification manager 349 may display or notify of an event such as an arrival message, promise, proximity notification, and the like in such a way that does not disturb a user. The location manager 350 may manage location information of an electronic device. The graphic manager 351 may manage a graphic effect which will be provided to a user, or a user interface related to the graphic effect. The security manager 352 may provide all security functions required for system security, user authentication, or the like. According to an embodiment of the present disclosure, when the electronic device (e.g., the electronic device 101) has a telephone call function, the middleware 330 may further include a telephony manager for managing a voice call function or a video call function of the electronic device.

The middleware 330 may include a middleware module that forms a combination of various functions of the above-described components. The middleware 330 may provide a module specialized for each type of OS in order to provide a differentiated function. Further, the middleware 330 may dynamically remove some of the existing components or add new components.

The API 360 (e.g., the API 145) is, for example, a set of API programming functions, and may be provided with a different configuration according to an OS. For example, in the case of Android or iOS, one API set may be provided for each platform. In the case of Tizen, two or more API sets may be provided for each platform.

The applications 370 (e.g., the application programs 147) may include, for example, one or more applications which may provide functions such as a home 371, a dialer 372, an SMS/MMS 373, an Instant Message (IM) 374, a browser 375, a camera 376, an alarm 377, contacts 378, a voice dial 379, an email 380, a calendar 381, a media player 382, an album 383, a clock 384, health care (e.g., measuring exercise quantity or blood sugar), or environment information (e.g., providing atmospheric pressure, humidity, or temperature information).

According to an embodiment of the present disclosure, the applications 370 may include an application (hereinafter, referred to as an “information exchange application” for convenience of description) that supports exchanging information between the electronic device (e.g., the electronic device 101) and an external electronic device (e.g., the electronic device 102 or 104). The information exchange application may include, for example, a notification relay application for transferring specific information to an external electronic device or a device management application for managing an external electronic device.

For example, the notification relay application may include a function of transferring, to the external electronic device (e.g., the electronic device 102 or 104), notification information generated from other applications of the electronic device 101 (e.g., an SMS/MMS application, an e-mail application, a health management application, or an environmental information application). Further, the notification relay application may receive notification information from, for example, an external electronic device and provide the received notification information to a user.

The device management application may manage (e.g., install, delete, or update), for example, at least one function of an external electronic device (e.g., the electronic device 102 or 104) communicating with the electronic device (e.g., a function of turning on/off the external electronic device itself (or some components) or a function of adjusting the brightness (or a resolution) of the display), applications operating in the external electronic device, and services provided by the external electronic device (e.g., a call service or a message service).

According to an embodiment of the present disclosure, the applications 370 may include applications (e.g., a health care application of a mobile medical appliance or the like) designated according to an external electronic device (e.g., attributes of the electronic device 102 or 104). According to an embodiment of the present disclosure, the applications 370 may include an application received from an external electronic device (e.g., the server 106, or the electronic device 102 or 104). According to an embodiment of the present disclosure, the applications 370 may include a preloaded application or a third party application that may be downloaded from a server. The names of the components of the program module 310 of the illustrated embodiment of the present disclosure may change according to the type of operating system.

According to various embodiments, at least a part of the programming module 310 may be implemented in software, firmware, hardware, or a combination of two or more thereof. At least some of the program module 310 may be implemented (e.g., executed) by, for example, the processor (e.g., the processor 210). At least some of the program module 310 may include, for example, a module, a program, a routine, a set of instructions, and/or a process for performing one or more functions.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter. According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable recoding media may be, for example, the memory 130.

The client and the server to be described below may refer to the electronic device 101 of FIG. 1 or the electronic device 201 of FIG. 2. However, the client may be described to refer to an object that can be used while moving, such as a smart phone, a tablet PC, or a mobile phone, and the server (e.g., the server 106) may be described to refer to an object for providing services to the client through networks. However, the client and the server are not limited to the description.

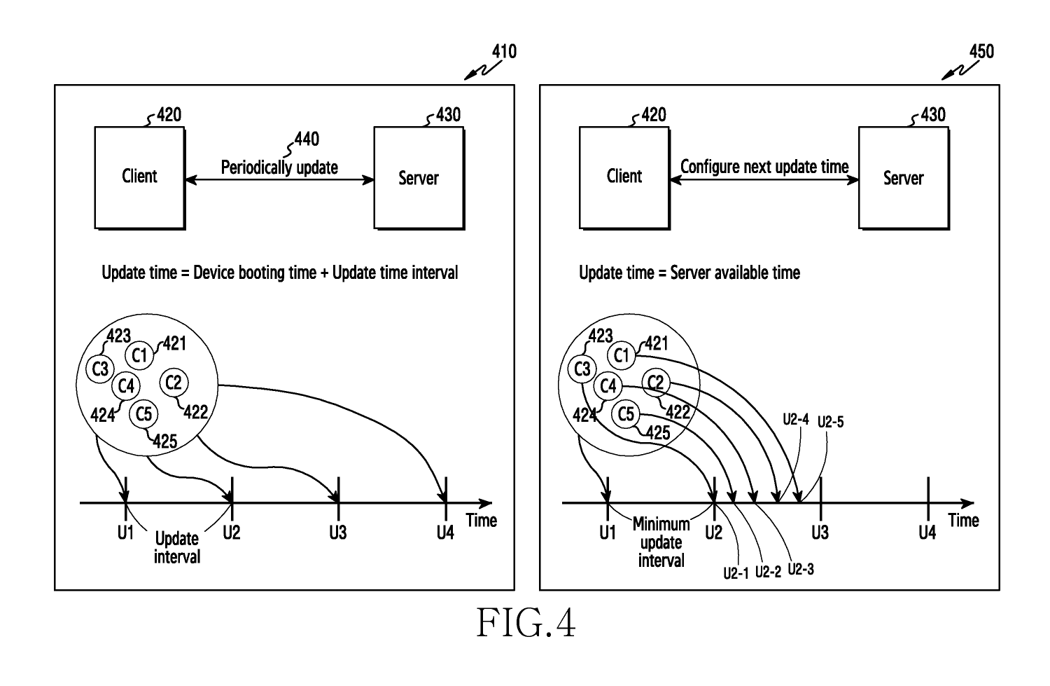

FIG. 4 illustrates a comparison between an embodiment of the present disclosure and the prior art a comparison between an embodiment of the present disclosure and the prior art.

Referring to FIG. 4, the prior art 410 shows that the client 420 (e.g., the electronic device 101) makes a request to the server 430 (e.g., the server 106) for the update 440 at the update time (e.g., the communication request time). The update request, for example, may be periodically made. The update request, for example, may be a request for services that are necessary for the client. The services may be firmware (e.g., an operating system) or applications (e.g., an application store, a weather application, or a traffic application) installed in the client. For example, the update time may be configured based on a device booting time and an update time interval. In the case where the client is an electronic device, the device booting time may be the time when power is applied to the electronic device to then be booted. The update time interval, for example, may refer to a time interval between updates, and may be an interval from the start time of the first update to the start time of the second update.

According to the prior art 410, a plurality of clients (e.g., the first client 421, the second client 422, the third client 423, the fourth client 424, and the fifth client 425) may simultaneously make a request to the server 430 for the update at the first update time U1. At this time, when the update request is made in a constant period, the second update time U2 (e.g., the next update time) of the plurality of clients 421 to 425 may be the same. Since the update time is configured based on the device booting time and the update time interval, the second update time will be the same among the plurality of clients 421 to 425 unless the clients are rebooted.

That is, although five clients are illustrated to simultaneously request the update in the drawing, the server 430 may be overloaded when 100 or 1000 clients make a request to the server 430 for the update at the same time. For example, in the case where 200 clients simultaneously make a request for the update to the server 430 of which the availability number is 100, the server 430 may be overloaded because the number of service requests (e.g., 200) exceeds the availability number (e.g., 100).

On the contrary, in an embodiment 450, when the client 420 makes a request to the server 430 for the update, the server 430 may configure the update time (e.g., the next update time or the communication request time) and may transmit the same to the client 420. At this time, the update time may be a server-available time. The server-available time means the time at which the server 430 can make an update, and may refer to the time in which the number of update reservations of the server 430 is less than the availability number of the server 430. According to the embodiment 450, when a plurality of clients 421 to 425 make a request to the server 430 for the update at the first update time U1, the server 430 may determine the second update times U2-1 to U2-5 for the plurality of clients 421 to 425 in consideration of the available time of the server 430.

For example, the server 430 may determine a point of time “U2-5” as the second update time U2-5 for the first client 421, may determine a point of time “U2-4” as the second update time U2-4 for the second client 422, may determine a point of time “U2-1” as the second update time U2-1 for the third client 423, may determine a point of time “U2-3” as the second update time U2-3 for the fourth client 424, and may determine a point of time “U2-2” as the second update time U2-2 for the fifth client 425. For reference, it may be seen that the second update times U2-1 to U2-5 are different from each other based on the time axis. Therefore, according to the embodiment 450, although a plurality of clients 421 to 425 have the same time of the first update time “U1”, the second update times U2-1 to U2-5 thereof may be configured to be different from each other. In this case, the server 430 may distribute the second update times of the plurality of clients 421 to 425 to be different between the second update time U2 and the third update time U3 in order to thereby disperse the load.

Hereinafter, a variety of methods for distributing the update time will be described with reference to the drawings.

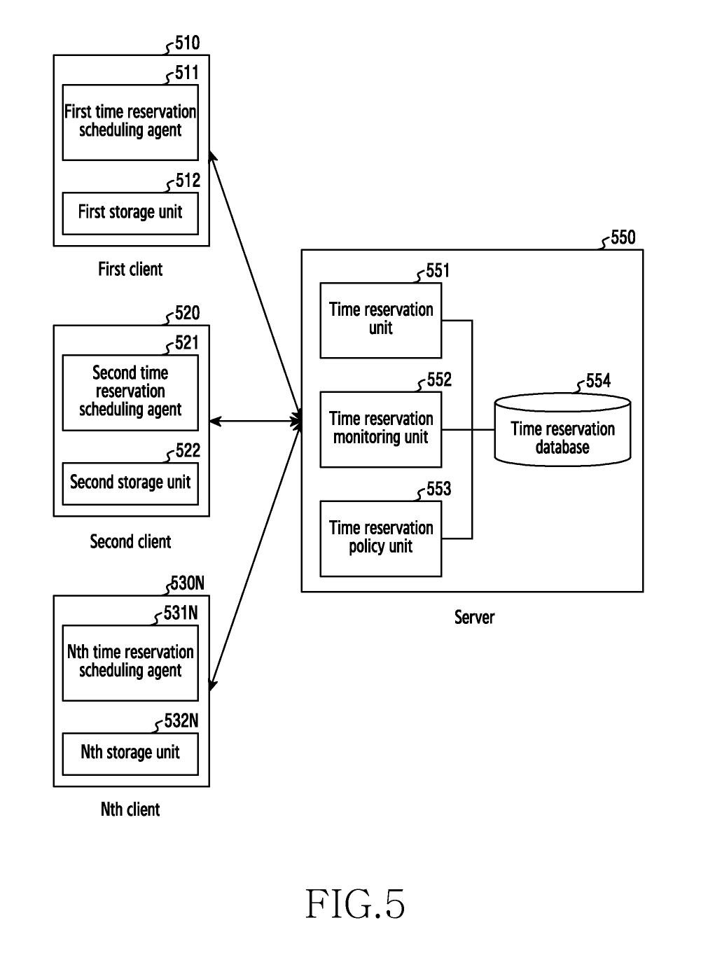

FIG. 5 illustrates the configuration of a system for processing the update according to various embodiments.

Referring to FIG. 5, a system 500 for processing the update, for example, may include a plurality of clients 510 to 530N and a server 550.

The server 550, for example, may include a time reservation unit 551, a time reservation monitoring unit 552, a time reservation policy unit 553, and a time reservation database 554. The time reservation unit 551 may process a service (e.g., update) request. The time reservation unit 551 may reserve a time for each of a plurality of clients 510 to 530N in an available time slot of the server 550, and may issue the reservation time (e.g., the communication request time or the next update time). The reservation time may be contained in reservation information to then be transmitted to the plurality of clients 510 to 530N. The time reservation monitoring unit 552 may calculate a threshold value of the reservation time based on at least one of a hit rate, a system load, or network traffic for the reservation time. The threshold value of the reservation time may refer to the reservable time or may refer to an interval of the reservable time. For example, the time reservation monitoring unit 552 may calculate the threshold value of the reservation time such that the reservation time does not exceed the available time of the server 550.

The time reservation policy unit 553 may apply the service priority and the threshold value of the reservation time when determining the reservation time. The service priority, for example, may be intended to differently apply different reservable time slots in a single available time (e.g., the first slot) depending on the type of service (e.g., application). The time reservation database 554 may store at least one of server information, the availability number, the reservation number, or the threshold value of the reservation time. The server information may contain a server identifier and access information of the server. The availability number may refer to the number of clients that can access the server at the same time. The reservation number may mean the number of clients that are reserved at a single available time.

Although it is not shown in the drawing, the server 550 may include a processor (e.g., the processor 120 or the processor 210) for calculating the reservation time and a communication unit (e.g., the communication interface 170 or the communication module 220) for transmitting the reservation time. In addition, the elements illustrated in FIG. 5 are not essential, so the server 550 may be implemented to have more elements than the elements of FIG. 5, or to exclude some thereof.

According to an embodiment, a plurality of clients 510 to 530N may make a request to the server 550 for a service. For example, the first client 510 may include the first time reservation scheduling agent 511 and the first storage unit 512. The first time reservation scheduling agent 511 may receive the reservation information from the server 550 to then store the same in the first storage unit 512, and may activate the reservation information. For example, if the current time corresponds to the reservation time contained in the reservation information, the first time reservation scheduling agent 511 may make a request to the server 550 for a service. Although it is not shown in the drawing, the first time reservation scheduling agent 511 may include a communication unit (e.g., the communication interface 170 or the communication module 220) for receiving the reservation information and for transmitting the service request. In addition, the first time reservation scheduling agent 511 may be included in the processor (e.g., the processor 120 or the processor 210) for activating the reservation information to then be executed.

In addition, the second client 520, for example, may include the second time reservation scheduling agent 521 and the second storage unit 522, and the Nth client 530N, for example, may include the Nth time reservation scheduling agent 531N and the Nth storage unit 532N. The second time reservation scheduling agent 521 and the Nth time reservation scheduling agent 531N may execute the same, or a similar, function as the first time reservation scheduling agent 511. The second storage unit 522 and the Nth storage unit 532N may execute the same, or a similar, function as the first storage unit 512.

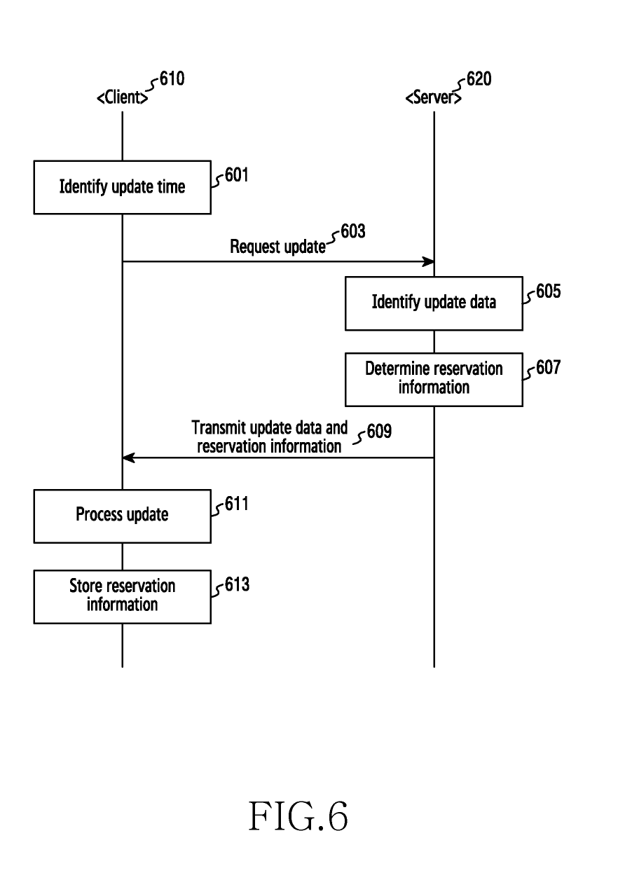

FIG. 6 illustrates a flowchart of a method for processing the update in the client and the server according to various embodiments.

Referring to FIG. 6, in operation 601, the client 610 (e.g., the first time reservation scheduling agent 511, the electronic device 101, or the electronic device 201) may identify the update time. The update time may be the reservation time at which the update is configured to be made. The update time may be stored in the storing unit (e.g., the memory 130) of the client 610. The client 610 may determine whether or not the update time is stored in the storage unit.

In operation 603, the client 610 (e.g., the first time reservation scheduling agent 511) may make a request to the server 620 (e.g., the electronic device 102 or the server 106) for the update. The update request may mean a request for data that is necessary for the update, and, for example, may contain service information (e.g., a version, the type, or an identifier of firmware or an application) to be updated. The client 610 may transmit information (e.g., device information or user information) on the client 610, such as a device identifier, a user ID, a phone number, or the like, together with the update request.

According to various embodiments, if the current time corresponds to the update time, the client 610 may make a request to the server 620 for the update. Alternatively, even though the update time is not stored in the storage unit, the client 610 may make a request to the server 620 for the update. For example, when an update event occurs, the client 610 may make a request to the server 620 for the update. For example, the update event may include at least one of booting, connecting to the wireless Internet, the type of application, the priority of an application, the user configuration, or the device configuration.

In operation 605, the server 620 (e.g., the time reservation unit 551) may identify the update data. The server 620 may receive the update request, and may identify the update data based on the information contained in the update request. For example, the server 620 may determine the update data based on the service information. In the case where a version 2.1.3 is contained in the service information and the latest version is 2.1.4, the server 620 may determine, as the update data, information to update the application with the latest version.

In operation 607, the server 620 (e.g., the time reservation unit 551) may determine the reservation information. In order to prevent overload caused by a plurality of clients that simultaneously request the update, the server 620 may transmit the time for the next update together with the update data when transmitting the update data to the client that have requested the update. To this end, the server 620 may determine the time for the next update based on the available time of the server, and may include, as the update reservation time (or the service request reservation time), the determined time in the reservation information. The reservation information may contain information (e.g., server access information or another reservation time) to be executed in case the update fails at the update reservation time, as well as the update reservation time.

In operation 609, the server 620 (e.g., the time reservation unit 551) may transmit the identified update data and the reservation information to the client 610. For example, the time reservation unit 551 may transmit the identified update data and the reservation information to the client 610 through the communication unit included in the server 620.

The client 610 (e.g., the communication interface 170 or the communication module 220) may receive the identified update data and the reservation information. In operation 611, the client 610 (e.g., the processor 120 or the processor 210) may process the update based on the received update data. For example, the client 610 may update the application with the latest version 2.1.4. by using the update data. Alternatively, in the case of an application related to the weather, the client 610 may update the application with the weather information corresponding to the current date (e.g., the date requested for the update) by using the update data. The client 610 may update the weather information of the area corresponding to the current location as well as the current date according to the configuration.

In operation 613, the client 610 (e.g., the first time reservation scheduling agent 511) may store the reservation information in the storage unit (e.g., the first storage unit 512, the memory 130, or the memory 230). The reservation information is received from the server 620, and may be renewed by each update. The client 610 may delete the original reservation information that has been stored in the storage unit at each update occurrence, and may store the reservation information that has recently been received.

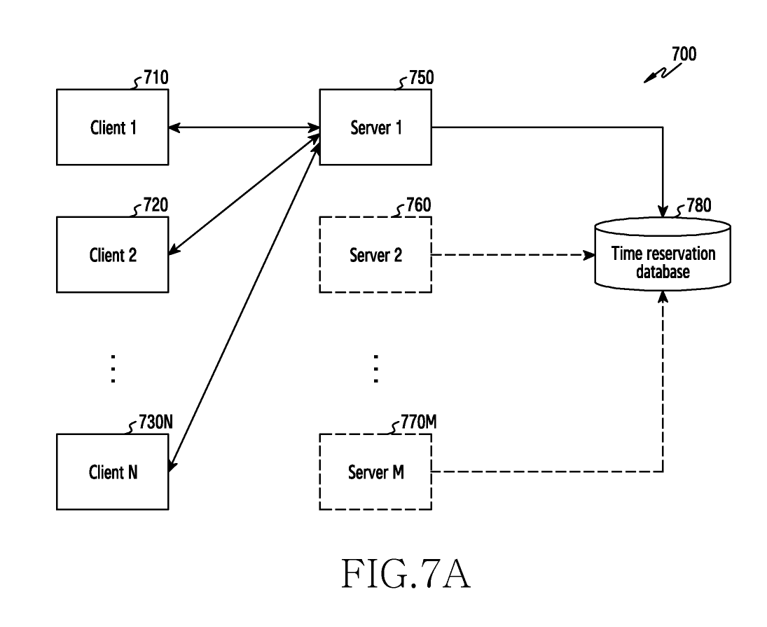

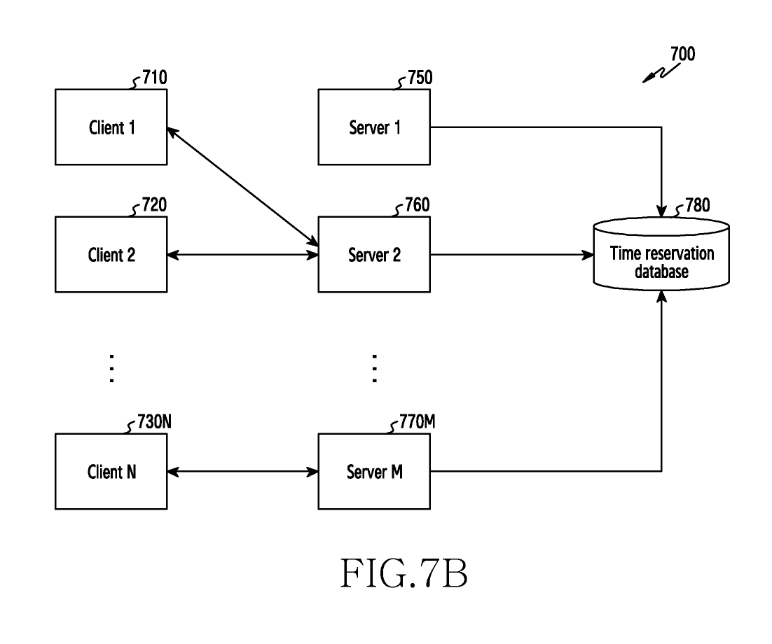

FIGS. 7A and 7B illustrate another configuration of a system for processing the update according to various embodiments.

FIG. 7A illustrates an example in which a plurality of clients (e.g., 710 to 730N) make a request to the same server (e.g., the first server 750) for the update. In FIG. 7A, since a plurality of clients 710 to 730N make a request to the first server 750 for the update, the remaining servers (e.g., the second server 760 and the Mth server 770M) may not be used. When the server is not used, it is possible to save the resources of the server and to reduce the server usage cost.

Referring to FIG. 7A, the system 700 for processing the update may include a plurality of clients 710 to 730N and a plurality of servers 750 to 770M. The first client 710 may make a request to the first server 750 for the update. The first client 710 may include the same, or similar, elements (e.g., the first time reservation scheduling agent 511 and the first storage unit 512) as the first client 510 of FIG. 5. The first client 710 may make a request to the first server 750 for the update through the time reservation scheduling agent. The first server 750 may receive the update request, and may transmit necessary data to the first client 710 in response to the request. The first server 750 may include the same, or similar, elements (e.g., the time reservation unit, the time reservation monitoring unit, and the time reservation policy unit) as the server 550 of FIG. 5.

According to various embodiments, in the case where a plurality of servers are configured, one or more servers may be master servers and the remaining servers may be slave servers. The master server or the slave server may be configured by a user or by an administrator. Here, the first server 750 will be described to be a master server and the second server 760 and the Mth server 770M will be described to be slave servers. However, the master server and the slave servers are not limited to the description above.

The time reservation database 780 may contain the availability number and the reservation number for each server. The availability number may refer to the number of clients that are available in each server (or the available time of the server). The reservation number may be the number of clients that have reserved the update in each server. According to various embodiments, the availability number or reservation number of the master server (e.g., the first server 750) may be less than that of the slave server (e.g., the second server 760 and the Mth server 770M).

The first server 750 may transmit the data necessary for the update and reservation information to the first client 710. The first server 750 may create the reservation information with reference to the time reservation database 780. The reservation information may contain server access information and update reservation time. The server access information may be access information to the first server 750, to the second server 760, or to the Mth server 770M. For example, the first server 750 may retrieve the reservation numbers of all the servers, which are stored in the time reservation database 780, and may determine, as the next access server, the server of which the reservation number is the minimum, or vice versa. The first server 750 may sort the servers into the order of the minimum reservation number, and may determine the next access servers in order of the minimum reservation number. Alternatively, the first server 750 may sort the servers into the order of the minimum difference between the availability number and the reservation number, and may determine the next access servers in order of the minimum difference, or vice versa.

For example, if the availability number of the first server 750 corresponding to the update reservation time is greater than the reservation number, the first server 750 may include the access information to the first server 750 in the reservation information. If the availability number of the first server 750 corresponding to the update reservation time is equal to, or less than, the reservation number, the first server 750 may include the access information to the second server 760 or to the Mth server 770M, instead of the access information to the first server 750, in the reservation information. For example, the first server 750 may determine the second server 760 to be a server that is to update the first client 710 next. The first server 750 may include the update reservation time and the access information to the second server 760 in the reservation information, and may transmit the same to the first client 710. In addition, the first server 750 may store, in the time reservation database 780, the update reservation time or the server access information, which is contained in the reservation information. For example, the first server 750 may increase the reservation number for the second server 760 by one to then be stored in the time reservation database 780.

The first client 710 may store the reservation information in the storage unit (e.g., the first storage unit 512). The first client 710 may process the subsequent update requests based on the reservation information.

The second client 720 may make a request to the first server 750 for the update. The second client 720 may include the same, or similar, elements (e.g., the second time reservation scheduling agent 521 and the second storage unit 522) as the second client 520 of FIG. 5. The second client 720 may make a request to the first server 750 for the update through the time reservation scheduling agent. The first server 750 may receive the update request, and may transmit the necessary data to the second client 720 in response to the request. The first server 750 may transmit the data necessary for the update and the reservation information to the second client 720. The first server 750 may create the reservation information based on the availability number and the reservation number for each server, which are stored in the time reservation database 780.

For example, the first server 750 may determine the second server 760 as a server that is to update the second client 720 next. The first server 750 may include the update reservation time and the access information to the second server 760 in the reservation information, and may transmit the same to the second client 720. The first server 750 may store, in the time reservation database 780, the update reservation time or the server access information, which is contained in the reservation information. For example, the first server 750 may increase the reservation number for the second server 760 by one to then be stored in the time reservation database 780. The second client 720 may store the reservation information in the storage unit (e.g., the second storage unit 522). The second client 720 may process subsequent update requests based on the reservation information.

The Nth client 730N may make a request to the first server 750 for the update. The Nth client 730N may include the same, or similar, elements (e.g., the Nth time reservation scheduling agent 531N and the Nth storage unit 532N) as the Nth client 530N of FIG. 5. The Nth client 730N may make a request to the first server 750 for the update through the time reservation scheduling agent. The first server 750 may receive the update request, and may transmit the necessary data to the Nth client 730N in response to the request. The first server 750 may transmit the data necessary for the update and the reservation information to the Nth client 730N. The first server 750 may create the reservation information based on the availability number and the reservation number for each server, which are stored in the time reservation database 780.

For example, the first server 750 may determine the Mth server 770M as a server that is to update the Nth client 730N next. The first server 750 may include the update reservation time and the access information to the Mth server 770M in the reservation information, and may transmit the same to the Nth client 730N. In addition, the first server 750 may store, in the time reservation database 780, the update reservation time or the server access information, which is contained in the reservation information. For example, the first server 750 may increase the reservation number for the Mth server 770M by one to then be stored in the time reservation database 780. The Nth client 730N may store the reservation information in the storage unit (e.g., the Nth storage unit 532N). The Nth client 730N may process subsequent update requests based on the reservation information.

As described above, the reservation information transmitted to the first client 710, the second client 720, and the Nth client 730N may be the same or may be different. For example, the update reservation time transmitted to the first client 710, the second client 720, and the Nth client 730N may be the same. The server access information transmitted to the first client 710, the second client 720, and the Nth client 730N may be the same or may be different. The reservation number of the server may be updated according to the server access information to then be stored in the time reservation database 780. According to various embodiments, the server to be accessed next may be determined based on the availability number and the reservation number of the server, which are stored in the time reservation database 780.

FIG. 7B illustrates an example in which a plurality of clients (e.g., 710 to 730N) make a request to different servers for the update, respectively. In FIG. 7B, since a plurality of clients 710 to 730N make a request to different servers (e.g., the second server 760 and the Mth server 770M), the plurality of servers may be used. That is, a plurality of servers may be used only when it is necessary (e.g., only at the update time), and may not be used when it is not necessary in order to thereby save the resources of the server and in order to thereby reduce the server usage cost.

Referring to FIG. 7B, the system 700 for processing the update may include a plurality of clients 710 to 730N and a plurality of servers 750 to 770M. The first client 710 may request the update based on reservation information stored in the storage unit (e.g., the first storage unit 512). For example, the first client 710 may determine whether or not the reservation information is stored in the storage unit. If the reservation information is stored in the storage unit, the first client 710 may identify the update reservation time and the server access information, which are contained in the reservation information. If the update reservation time is equal to the current time, the first client 710 may make a request for the update to the server (e.g., the second server 760) corresponding to the server access information.

The second server 760 may receive the update request from the first client 710, and may transmit the data necessary for the update and reservation information to the first client 710. The second server 760 may include the same, or similar, elements (e.g., the time reservation unit, the time reservation monitoring unit, and the time reservation policy unit) as the server 550 of FIG. 5. The second server 760 may create the update reservation time and the server access information based on the availability number and the reservation number for each server, which are stored in the time reservation database 780.

For example, if the availability number of the second server 760 corresponding to the update reservation time is greater than the reservation number, the second server 760 may include the access information to the second server 760 in the reservation information. If the availability number of the second server 760 corresponding to the update reservation time is equal to, or less than, the reservation number, the second server 760 may include the access information to the first server 750 or to the Mth server 770M, instead of the access information to the second server 760, in the reservation information. For example, the second server 760 may determine the second server 760 to be a server that is to update the first client 710 next. The second server 760 may include the update reservation time and the access information to the second server 760 in the reservation information, and may transmit the same to the first client 710. In addition, the second server 760 may store, in the time reservation database 780, the update reservation time or the server access information, which is contained in the reservation information. For example, the second server 760 may increase the reservation number for the second server 760 by one to then be stored in the time reservation database 780.

The first client 710 may receive the reservation information from the second server 760, and may store the received reservation information. That is, the first client 710 may update the reservation information. For example, the first client 710 may delete the reservation information that has been stored in FIG. 7A, and may store the reservation information received in FIG. 7B in the storage unit.

The second client 720 may request the update based on the reservation information stored in the storage unit (e.g., the second storage unit 522). For example, the second client 720 may determine whether or not the reservation information is stored in the storage unit. If the reservation information is stored in the storage unit, the second client 720 may identify the update reservation time and the server access information contained in the reservation information. If the update reservation time is the same as the current time, the second client 720 may make a request for the update to the server (e.g., the second server 760) corresponding to the server access information.

The second server 760 may receive the update request from the second client 720, and may transmit the data necessary for the update and the reservation information to the second client 720. The second server 760 may create the update reservation time and the server access information based on the availability number and the reservation number for each server, which are stored in the time reservation database 780. For example, if the availability number of the second server 760 corresponding to the update reservation time is greater than the reservation number, the second server 760 may include the access information to the second server 760 in the reservation information. If the availability number of the second server 760 corresponding to the update reservation time is equal to, or less than, the reservation number, the second server 760 may include the access information to the first server 750 or to the Mth server 770M, instead of the access information to the second server 760, in the reservation information.

For example, the second server 760 may determine the first server 750 to be a server that is to update the second client 720 next. The second server 760 may include the update reservation time and the access information to the first server 750 in the reservation information, and may transmit the same to the second server 760. In addition, the second server 760 may store, in the time reservation database 780, the update reservation time or the server access information, which is contained in the reservation information. For example, the second server 760 may increase the reservation number for the first server 750 by one to then be stored in the time reservation database 780.

The second client 720 may receive the reservation information, and may store the received reservation information. The second client 720 may delete the reservation information that has been stored in FIG. 7A, and may store the reservation information received in FIG. 7B in the storage unit.

The Nth client 730N may request the update based on reservation information stored in the storage unit (e.g., the Nth storage unit 532N). For example, the Nth client 730N may determine whether or not the reservation information is stored in the storage unit. If the reservation information is stored in the storage unit, the Nth client 730N may identify the update reservation time and server access information contained in the reservation information. If the update reservation time is the same as the current time, the Nth client 730N may make a request for the update to the server (e.g., the Mth server 770M) corresponding to the server access information.

The Mth server 770M may receive the update request from the Nth client 730N, and may transmit the data necessary for the update and the reservation information to the Nth client 730N. The Mth server 770M may include the same, or similar, elements (e.g., the time reservation unit, the time reservation monitoring unit, and the time reservation policy unit) as the server 550 of FIG. 5. The Mth server 770M may create the update reservation time and the server access information based on the availability number and the reservation number for each server, which are stored in the time reservation database 780.

For example, if the availability number of the Mth server 770M corresponding to the update reservation time is greater than the reservation number, the Mth server 770M may include the access information to the Mth server 770M in the reservation information. If the availability number of the Mth server 770M corresponding to the update reservation time is equal to, or less than, the reservation number, the Mth server 770M may include the access information to the first server 750 or to the second server 760, instead of the access information to the Mth server 770M, in the reservation information. For example, the Mth server 770M may determine the Mth server 770M to be a server that is to update the Nth client 730N next. The Mth server 770M may include the update reservation time and the access information to the Mth server 770M in the reservation information, and may transmit the same to the Nth client 730N. The Mth server 770M may store, in the time reservation database 780, the update reservation time or the server access information, which is contained in the reservation information. For example, the Mth server 770M may increase the reservation number for the Mth server 770M by one to then be stored in the time reservation database 780.

The Nth client 730N may receive the reservation information, and may store the received reservation information. The Nth client 730N may delete the reservation information which has been stored in FIG. 7A, and may store the reservation information received in FIG. 7B in the storage unit.

An electronic device, according to various embodiments, may include: a communication interface; a memory that is configured to store the reservation time to perform communication with a plurality of external devices; and a processor that is functionally connected to the communication interface and the memory, wherein the processor is configured to: receive a service request from at least one of the plurality of external devices through the communication interface; determine the communication request time that is related to the service request based on the reservation time stored in the memory and the load that is related to the reservation time; and transmit the determined communication request time to the at least one external device through the communication interface.

The processor may be configured to: identify the communication request time based on the service request; and determine the communication request time based on the reservation time to perform communication with the plurality of external devices and the load of the processor at the reservation time.

The processor may be configured to determine, as the communication request time related to the service request, the time that satisfies a predetermined condition among the reservation time to perform communication with the plurality of external devices.

The processor may be configured to determine, as the communication request time, the time to process a work that is less than a reference value among the load related to the processor.

The processor may be configured to select the communication request time based on service information and device information, which are contained in the service request.

The processor may be configured to select the communication request time based on the availability number or reservation number of the reservation time.

The processor may be configured to determine whether or not to apply the priority based on service information contained in the service request, and select a slot based on the determination result.

The processor may be configured to: divide time into a plurality of slots; select a slot after the minimum service request interval among the divided slots; and determine the communication request time in the selected slot.

The processor may be configured to: determine whether or not the reservation number of the selected slot is equal to, or less than, the availability number; and determine the communication request time in the selected slot if the reservation number is less than the availability number.

The processor may be configured to: determine whether or not the reservation number of the selected slot is less than the availability number; select another slot if the reservation number is equal to the availability number; and determine the communication request time in another slot that has been selected.

The processor may be configured to: divide time into a plurality of slots; select a slot after the minimum service request interval among the divided slots; identify the priority of service information that is contained in the service request in the selected slot; and determine the communication request time in the selected slot based on the availability number or reservation number corresponding to the priority.

The processor may be configured to determine whether the reservation number corresponding to the priority is equal to, or less than, the availability number; and determine the communication request time in the selected slot if the reservation number is less than the availability number.

The processor may be configured to: determine whether or not the reservation number corresponding to the priority is less than the availability number; select another slot if the reservation number is equal to the availability number; identify the priority of service information that is contained in the service request in another slot that has been selected; and determine the communication request time in another slot based on the availability number or reservation number corresponding to the priority.

An electronic device, according to various embodiments, may include: a memory that is configured to store reservation information that is related to a service request; and a processor that is functionally connected to the memory, wherein the processor is configured to: determine whether or not the reservation information is stored in the memory according to the detection of a service request event; and transmit the service request to an external device at the communication request time contained in the reservation information or at the detection time of the service request event based on the determination result.

The processor may be configured to: compare the current time with the communication request time contained in the reservation information if the reservation information is stored in the memory; and transmit the service request if the current time matches the communication request time.

The processor may be configured to transmit the service request at the detection time of the service request event if the reservation information is not stored in the memory.

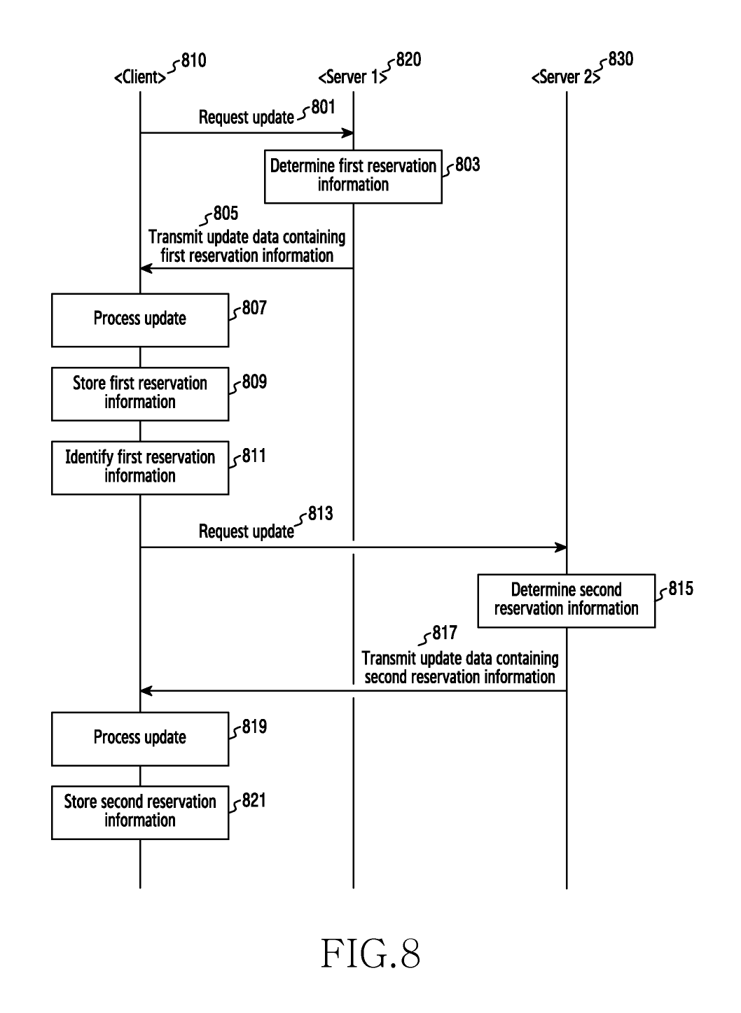

FIG. 8 illustrates a flowchart of a method for processing the update in the client and the server according to various embodiments.

Referring to FIG. 8, in operation 801, the client 810 (e.g., the first time reservation scheduling agent 511 or the processor 120) may make a request to the first server 820 for the update. The client 810 may include the same, or similar, elements (e.g., the first time reservation scheduling agent 511 and the first storage unit 512) as the first client 510 of FIG. 5. The client 810 may make a request to the first server 820 for the update through the time reservation scheduling agent. The client 810 may transmit service information (e.g., a version, the type, or an identifier of an application) to be updated and information on the client 810 (e.g., a device identifier, a user ID, a phone number, or the like) together with the update request.

According to various embodiments, if the current time corresponds to the update reservation time, the client 810 may make a request to the first server 820 for the update. Alternatively, even though the update reservation time is not stored in the storage unit, the client 810 may make a request to the first server 820 for the update. For example, when an update event occurs, the client 810 may make a request to the first server 820 for the update. For example, the update event may include at least one of booting, connecting to the wireless Internet, the type of application, the priority of an application, the user configuration, or the device configuration.

In operation 803, the first server 820 (e.g., the time reservation unit 551) may receive the update request, and may determine the first reservation information in response to the request. The first server 820 may include the same, or similar, elements (e.g., the time reservation unit, the time reservation monitoring unit, and the time reservation policy unit) as the server 550 of FIG. 5. The first server 820 may identify the update data based on the information (e.g., the service information and the client information) contained in the update request. For example, the first server 820 may determine the update data based on the service information. The first server 820 may create the first reservation information with reference to the time reservation database (e.g., the time reservation database 780).

For example, the first server 820 may retrieve the reservation numbers of all the servers, which are stored in the time reservation database, and may determine, as the next access server, the server of which the reservation number is the minimum. The first server 820 may sort the servers into the order of the minimum reservation number, and may determine the next access servers in order of the minimum reservation number. Alternatively, the first server 820 may sort the servers into the order of the minimum difference between the availability number and the reservation number, and may determine the next access servers in order of the minimum difference.

In operation 805, the first server 820 (e.g., the time reservation unit 551) may transmit the data including the first reservation information to the client 810. The first reservation information may contain the update reservation time and the server access information (e.g., the access information to the second server 830). The first server 820 may store, in the time reservation database, the update reservation time or the server access information, which is contained in the reservation information. For example, the first server 820 may increase the reservation number for the second server 830 by one to then be stored in the time reservation database. The first reservation information is intended to be distinct from the second reservation information that will be described later, and the present disclosure is not limited thereto. The data may contain the first reservation information and the update data.

In operation 807, the client 810 (e.g., the processor 120) may receive the data, and may process the data. If the data is the update data, the processing of the data may be interpreted as processing the update. For example, the client 810 may update the weather according to the current date or the current location, or may update firmware or applications with the latest version.

In operation 809, the client 810 (e.g., the first time reservation scheduling agent 511) may store the first reservation information in the storage unit. For example, if the reservation information is stored in the storage unit, the client 810 may delete the stored reservation information, and may store the first reservation information.

In operation 811, the client 810 (e.g., the first time reservation scheduling agent 511) may identify the first reservation information. For example, the client 810 may identify the first reservation information that is stored in the storage unit in order to thereby determine whether or not the current time corresponds to the update reservation time. For example, the current time may be 9:00 am Jul. 1, 2015, and the update reservation time may be 9:00 am every day or may be 9:00 am Jul. 1, 2015. If the update reservation time corresponds to the current time, the client 810 may perform operation 813.

In operation 813, the client 810 (e.g., the first time reservation scheduling agent 511) may request the update based on the first reservation information. For example, if the server access information contained in the first reservation information corresponds to the second server 830, the client 810 may make a request to the second server 830 for the update. For example, the client 810 may transmit, to the second server 830, an update request containing the service information and the information on the client 810.

According to various embodiments, if the reservation information is not stored in the storage unit, the client 810 may wait without requesting the update. Afterwards, if an update event occurs, the client 810 may make a request to the first server 820 for the update.

In operation 815, the second server 830 (e.g., the time reservation unit 551) may receive the update request, and may determine the second reservation information in response to the request. The second server 830 may include the same, or similar, elements (e.g., the time reservation unit, the time reservation monitoring unit, and the time reservation policy unit) as the server 550 of FIG. 5. The second server 830 may identify the update data based on the information (e.g., the service information and the client information) contained in the update request. In addition, the second server 830 may create the second reservation information with reference to the time reservation database.

For example, the second server 830 may retrieve the reservation numbers of all the servers, which are stored in the time reservation database, and may determine, as the next access server, the server of which the reservation number is the minimum. The second server 830 may sort the servers into order of the minimum reservation number, and may determine the next access servers in the order of the minimum reservation number. Alternatively, the second server 830 may sort the servers into order of the minimum difference between the availability number and the reservation number, and may determine the next access servers in the order of the minimum difference.

In operation 817, the second server 830 (e.g., the time reservation unit 551) may transmit data containing the second reservation information to the client 810. The second reservation information may contain the update reservation time and the server access information (e.g., the access information to the second server 830). The second server 830 may store, in the time reservation database, the update reservation time or the server access information, which is contained in the reservation information. For example, the second server 830 may increase the reservation number for the second server 830 by one to then be stored in the time reservation database.

In operation 819, the client 810 (e.g., the processor 120) may receive the data, and may process the data. If the data is the update data, the processing of the data may be interpreted as processing the update.

In operation 821, the client 810 (e.g., the first time reservation scheduling agent 511) may store the second reservation information in the storage unit. That is, the client 810 may update the reservation information stored in the storage unit. For example, the client 810 may delete the first reservation information that has been stored in the storage unit, and may store the second reservation information. Then, the client 810 may process the update request based on the second reservation information.

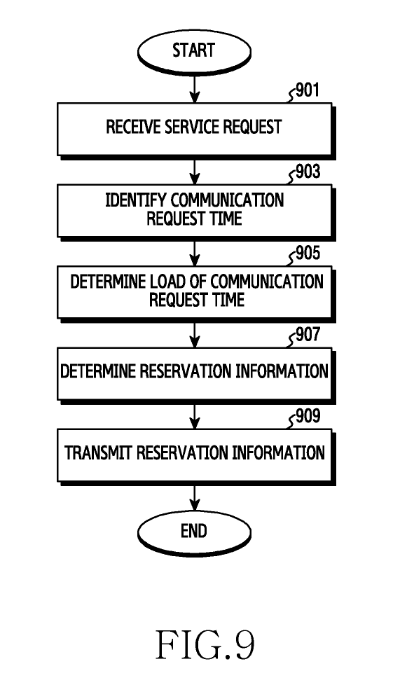

FIG. 9 illustrates a flowchart of an update processing method according to various embodiments.

Referring to FIG. 9, in operation 901, the server (e.g., the communication interface 170) may receive a service request (e.g., the update request) from the electronic device (e.g., the client 810). The service request may contain service information and device information. The service information may contain at least one of a version, the type, or an identifier of the firmware or application to be updated. The device information may contain at least one of an identifier of the electronic device, a user ID, or the phone number of the electronic device.

In operation 903, the server (e.g., the time reservation unit 551 or the processor 120) may identify the communication request time in response to the service request. According to the identification of the communication request time, the time when the next update is necessary may be identified based on the service information. For example, if the update is required at a specific time (e.g., 9:00 am), the specific time may be the communication request time. Alternatively, if the update is required in a constant period (e.g., 12 hours, a day, or a week), the time after the minimum update interval (e.g., 12 hours or 24 hours) may be the communication request time.

In operation 905, the server (e.g., the time reservation monitoring unit 552 or the processor 120) may determine the load of the communication request time. For example, the server may determine whether or not the reservation number that are made at the communication request time is equal to, or less than, the availability number of the server based on the time reservation database (e.g. the memory 130). The availability number or the reservation number for at least one server may be stored in the time reservation database.

Table 1 shows the information stored in the reservation time database.

TABLE 1

| Items | Description |
|---|---|
| Server access information | Information on server to be accessed at next |
| | service request |
| Minimum communication | Time interval between two service requests |
| request time interval | |
| Slot start time | Start time of one slot |
| Slot end time | End time of one slot |
| Available information of | The number of service requests that can be |
| slot | processed |
| Reservation information | The number of service requests that have |
| of slot | been reserved |

Referring to Table 1, the reservation number may be the number of electronic devices that have reserved the service request at the communication request time. The availability number may refer to the number of service requests of the electronic devices, which can be processed by the server at one time (e.g., at a time or during the time). For example, if the availability number is 100 and the reservation number is 80 at the communication request time, the server may determine that no load has occurred at the communication request time. Alternatively, if the availability number is 100 and the reservation number is 100 at the communication request time, the server may determine that the load has occurred at the communication request time.

According to various embodiments, the server may determine the load of the communication request time based on the service information. For example, the reservation number of the server with respect to the availability number of the server may be differently configured according to the service information. In the case where the availability number of the server is 100, the reservation number (e.g., the number of reservations that can be made) for the first service information may be configured to be 50, and the reservation number for the second service information and the reservation number for the third service information may be configured to be 30 and 20, respectively. If the service information is the first service information and the reservation number of the first service information stored in the memory is 40, the server may determine that the load has not occurred at the communication request time. Alternatively, if the service information is the third service information and the reservation number of the third service information stored in the memory is 20, the server may determine that the load has occurred at the communication request time.

According to various embodiments, the server may determine the load of another server at the communication request time based on the service information. For example, in some cases, the service request is to be made only at a specific time depending on the service. For this reason, according to various embodiments, a plurality of servers may be configured. However, not all of the plurality of servers may be used, and some of them may be used as necessary. For example, if the service information states that the service request is to be processed only at the communication request time, the server may determine the load of another server. For example, if the availability number of the first server is 100 and the reservation number is 100 at the communication request time, the server (e.g., the first server) may determine that the load has occurred with respect to the first server. Alternatively, if the availability number of the second server is 100 and the reservation number is 80 at the communication request time, the server may determine that the load has not occurred with respect to the second server.

In operation 907, the server (e.g., the time reservation unit 551 or the processor 120) may determine the reservation information based on the result of the load determination. If it is determined that the load has not occurred at the communication request time, the server may determine the identified communication request time as the reservation information. For example, if the availability number is 100 and the reservation number is 80 at the communication request time, the server may determine the communication request time as the reservation information. When the communication request time is determined, the server may increase the reservation number of the communication request time by one to then store the same in the memory.

According to various embodiments, if it is determined that the load has occurred at the identified communication request time (e.g., the first communication request time), the server may identify another communication request time (e.g., the second communication request time). The server may repeatedly perform operations 903 to 907 in order to identify another communication request time. For example, if the availability number is 100 and the reservation number is 100 at the communication request time, the server may determine that the load has occurred at the communication request time. The server may retrieve the availability number or the reservation number of the server at another communication request time, and may determine another communication request time as the reservation information based on whether or not the reservation number is equal to, or less than, the availability number.

According to various embodiments, if it is determined that the load has not occurred in the server at the communication request time, the server may determine the identified communication request time and the access information to the server as the reservation information. The server access information may be the information on the server that processes the service request at the communication request time. For example, if the availability number of the first server (e.g., the server) is 100 and the reservation number is 100 at the communication request time, the server may retrieve the availability number or the reservation number of another server (e.g., the second server), which is stored in the memory. If the availability number of the second server is 100 and the reservation number is 100 at the communication request time, the server may determine the reservation information such that the update can be made through the second server at the communication request time. The reservation information may contain the communication request time and the access information to the second server.

In operation 909, the server (e.g., the communication interface 170) may transmit the reservation information to the electronic device.

According to an embodiment, the electronic device 101 may execute an application (e.g., the application program 147) that receives the data from the server 106. For example, one or more applications may be downloaded from the server. The electronic device may display a main screen of the application through the display 160 in response to the execution of the application. The main screen of the application may contain an interface that includes at least one area for displaying the information obtained from the server 106. For example, there may be areas for displaying recommended applications for each category, user-recommended applications, popular weekly applications, or popular monthly applications. The electronic device 101 may transmit, to one or more servers, a service request for receiving the information corresponding to each area through different application programming interfaces (API) of the applications.

According to various embodiments, the server 106 may determine a response time to the service request based on the type of the API or the priority, which is received from the electronic device 101. For example, regarding the recommended applications for each category or the user-recommended applications, the server 106 may immediately transmit a response to the service request to the electronic device 101 in response to the service request. However, since there may be no change in the information related to the popular weekly applications or the popular monthly applications, or since the popular weekly applications or the popular monthly applications may have a low priority, the server 106 may not immediately transmit a response to the service request.

According to an embodiment, the electronic device 101 may periodically make a service request. For example, the electronic device 101 may periodically make a request to the server 106 for the information related to the user-recommended applications. The server 106 may immediately respond to the service request, or may put off the response to the service request based on the amount of work that is to be processed by the server 106. The server 106 may change the period of service request based on the amount of work. For example, if the processor of the server 106 has a large amount of work at a specific time, the server 106 may change the period of service request into the off-peak hours. Among the works that are to be processed at a specific time, the work of which the period of service request is changed may be determined according to the priority of the work or API.

According to an embodiment, the server 106 may determine the response time to the service request based on the context of the user corresponding to the electronic device 101. For example, if the user selects the user-recommended application area from the recommended applications for each category, the user-recommended applications, the popular weekly applications, or the popular monthly applications, and proceeds to the sub-screen thereof, or if the user frequently downloads one of the recommended applications, the server 106 may increase the priority of the response time to the service request. In contrast, if it is determined that the user's interest is relatively low or that the update is not required immediately, the server 106 may lower the priority of the response time to the service request.

According to an embodiment, the server 106 may store the execution time (e.g., the reservation time) of each service request in the memory based on the service requests received from a plurality of electronic devices. The server 106 may determine the execution time of a response to the service request based on the execution time stored in the memory. For example, the server 106 may determine the communication request time that is related to the service request based on the reservation time and the load associated with the reservation time, which are stored in the memory.

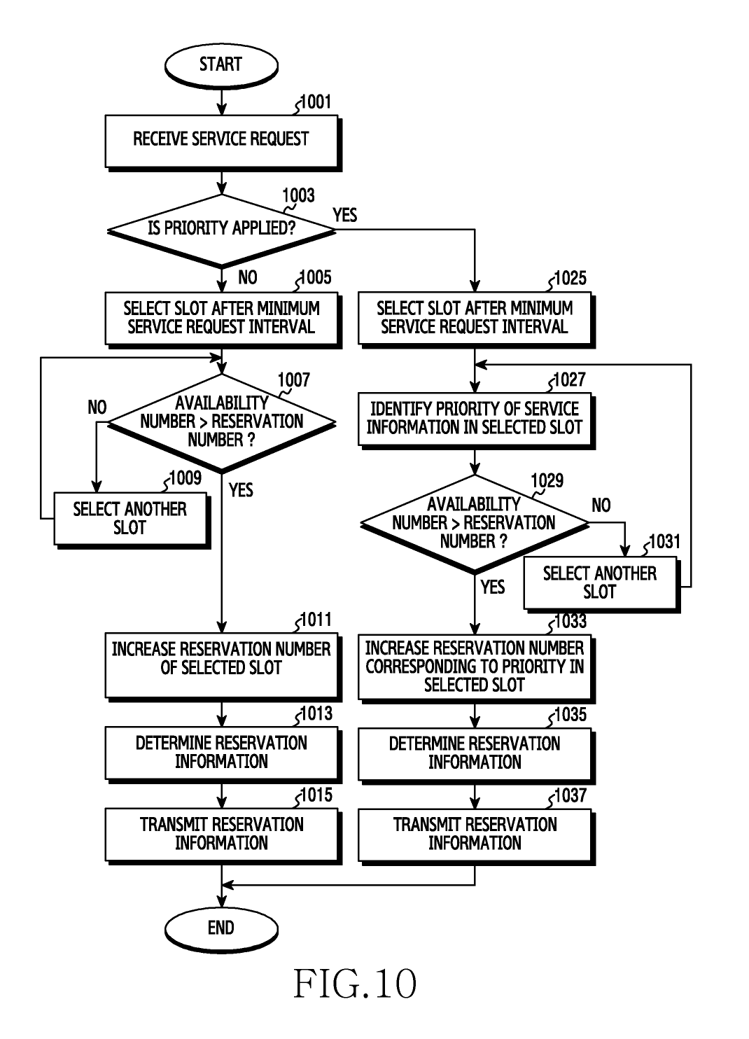

FIG. 10 illustrates a flowchart of a method for processing the update in various manners according to various embodiments.

Referring to FIG. 10, in operation 1001, the server (e.g., the communication interface 170) may receive a service request from the electronic device. The service request may contain service information and device information. The service information may contain at least one of a version, the type, or an identifier of firmware or an application that needs the update. The device information may contain at least one of a device identifier, a user ID, or a phone number.

In operation 1003, the server (e.g., the processor 120) may determine whether or not to apply the priority based on the service request. The priority may be configured based on the service information. For example, the service information may be classified into at least one of a usage pattern collection service, a latest information providing service, or an app-store service (e.g., an application store service) according to the type of service. The usage pattern collection service is intended to improve an application function by analyzing the history for the use of the application by the user of the electronic device. The usage pattern collection service may have a low priority because the update period can be configured to be different for each electronic device based on the configuration of the electronic device. The latest information providing service is intended to provide newspaper, magazine, or broadcast information. The latest information providing service may be configured to update the electronic device only when the electronic device is connected to the wireless Internet (e.g., Wi-Fi) because the server may transmit a large amount of data to the electronic device.

The app-store service is intended to provide the latest information about the applications that are installed in the electronic device. For example, the applications associated with the app-store service may be configured with different service request periods according to the type thereof (e.g., downloaded applications or preload applications). For example, the service request period for the application that has high importance may be configured to be short among the applications related to the app-store services. Alternatively, the service request period may be configured to be short according to the frequency of using the application in association with user pattern collection service. Alternatively, in the case of a promotion or periodic update of the application, the promotion time or the update time may be configured as the communication request time. Alternatively, in the case of an application (e.g., a weather application) that is required to be updated at a specific time, the number of servers may be configured to be increased at a specific time.

The server may perform operation 1005 when the priority is not applied, and may perform operation 1025 when the priority is applied.

When the priority is not applied, the server (e.g., the processor 120) may select a slot after the minimum service request interval in operation 1005. The minimum service request interval may be configured based on the service request period. For example, if the service request period is 12 hours, the minimum service request interval may be 12 hours. For example, the server may divide time (e.g., 24 hours) into one or more slots (e.g., 1 hour). That is, the server may divide a day into 24 slots (for example, slot 1 from 0:00 am to 1:00 am, slot 2 from 1:00 am to 2:00 am, slot 3 from 2:00 am to 3:00 am, and the like). In this case, the server may select the slot (e.g., slot 21 from 20:00 to 21:00) after the minimum service request interval (e.g., 12 hours) from the time (e.g., 9:00 am) when the service request is received.

In operation 1007, the server (e.g., the processor 120) may determine whether or not the availability number of the selected slot is greater than the reservation number. The availability number may be interpreted as the number of service requests that can be accepted. The reservation number may be interpreted as the number of service requests that have been reserved. The server may determine whether or not the availability number of the selected slot is greater than the reservation number based on the time reservation database (e.g. the memory 130). If the availability number of the selected slot is greater than the reservation number, the server may perform operation 1011, and if the availability number of the selected slot is equal to the reservation number, the server may perform operation 1009. For example, if the availability number of the selected slot 21 is 100 and the reservation number (e.g., 99) is less than 100, the server may perform operation 1011, and if the reservation number is equal to 100, the server may perform operation 1009.

If the availability number of the selected slot is equal to the reservation number, the server may select another slot in operation 1009. For example, the server may select a slot {e.g., the slot 22 (21:00 to 22:00)} after the selected slot (e.g., the slot 21). When another slot is selected, the server may perform operation 1007 again in order to thereby perform operation 1011 or operation 1009 based on the availability number or reservation number of another slot. For example, if the availability number of another slot is greater than the reservation number, the server may perform operation 1011, and if the availability number of another slot is equal to, or less than, the reservation number, the server may perform operation 1009.

In operation 1011, the server (e.g., the processor 120) may increase the reservation number of the selected slot. For example, since the server processes the service request for a single electronic device, the server may increase the reservation number by one. When the reservation number increases, the server may update the reservation number that is stored in the time reservation database. For example, if the reservation number is 99 before performing operation 1011, the reservation number after performing operation 1011 will be 100.

In operation 1013, the server (e.g., the processor 120) may determine the reservation information. The server may determine the communication request time in the selected slot. For example, the server may determine the communication request time to be 20:05 in the selected slot (e.g., the slot 21). The reservation information may contain the communication request time (e.g., 20:05).

In operation 1015, the server (e.g., the communication interface 170) may transmit the reservation information to the electronic device. The electronic device may receive the reservation information, and may store the received reservation information.

In the case of applying the priority, the server may select a slot after the minimum service request interval in operation 1025. Operation 1025 is similar to operation 1005 described above, so the detailed description thereof will be omitted. For example, the server may divide time (e.g., 24 hours) into one or more slots (e.g., 1 hour), and may select a slot {e.g., the slot 21 (20:00 to 21:00)} after the minimum service request interval (e.g., 12 hours) from the time (e.g., 9:00 am) when the service request is received.

In operation 1027, the server (e.g., the processor 120) may identify the priority of the service information in the selected slot. The priority may be differently configured depending on the service information as described above. For example, the priority may be determined from highest to lowest as a sequence of the app-store service>the latest information providing service>the usage pattern collection service. Alternatively, the priority may be determined from highest to lowest as a sequence of the app-store service>the usage pattern collection service>the latest information providing service. Alternatively, the priority may be determined from highest to lowest as a sequence of the latest information providing service>the app-store service>the usage pattern collection service. According to various embodiments, the priority may be different according to the applications even in the same service.

In operation 1029, the server (e.g., the processor 120) may determine whether or not the availability number corresponding to the priority of the selected slot is greater than the reservation number. According to various embodiments, the server may differently allocate the availability number of a single slot based on the priority. For example, if the availability number of the slot is 100, the server may allocate availability numbers of 50, 30, and 20 to the first priority, the second priority, and the third priority, respectively. In this case, since the availability number allocated to each service varies in the same slot, the reservation number of each service may vary depending on the availability number.

According to various embodiments, each priority may correspond to one or more services. For example, in the case where the availability numbers of the slot are divided into three priorities, the first priority, the second priority, and the third priority may correspond to 10 services (or applications), 50 services, and 100 services, respectively. This is intended for understanding, and the number of services corresponding to the priority is not limited thereto.

The time reservation database may store the availability number or the reservation number for each slot depending on the priority. For example, when the server receives a service request for the first service in operation 1001, the server may identify the priority of the first service, and may retrieve the availability number or the reservation number, which is allocated to the priority of the first service of the selected slot, from the time reservation database. If the availability number allocated to the priority of the first service is greater than the reservation number, the server may perform operation 1033, and if the availability number of the selected slot is equal to the reservation number, the server may perform operation 1031. For example, if the availability number allocated to the priority of the first service is 50 and the reservation number is 40, the server may perform operation 1033, and if the reservation number is 50, the server may perform operation 1031.

If the availability number of the select slot is equal to the reservation number, the server may select another slot in operation 1031. For example, the server may select a slot {e.g., the slot 22 (21:00 to 22:00)} after the selected slot (e.g., the slot 21). When another slot is selected, the server may perform operation 1027 again in order to thereby perform operation 1029 or operation 1031 based on the priority of the service in another slot. For example, if the availability number allocated to the priority of the service in another slot is greater than the reservation number, the server may perform operation 1033, and if the availability number allocated to the priority of the service of another slot is equal to the reservation number, the server may perform operation 1031.

In operation 1033, the server (e.g., the processor 120) may increase the reservation number corresponding to the priority in the selected slot. For example, since the server processes the service request for a single electronic device, the server may increase the reservation number by one. When the reservation number increases, the server may update the reservation number of the priority in the slot, which is stored in the time reservation database. For example, if the reservation number is 40 before performing operation 1033, the reservation number after performing operation 1033 will be 41.

In operation 1035, the server (e.g., the processor 120) may determine the reservation information. The server may determine the communication request time in the selected slot. For example, the server may determine the communication request time to be 20:10 in the selected slot (e.g., the slot 21). The reservation information may contain the communication request time (e.g., 20:10).

In operation 1037, the server (e.g., the communication interface 170) may transmit the reservation information to the electronic device. The electronic device may receive the reservation information, and may store the received reservation information.

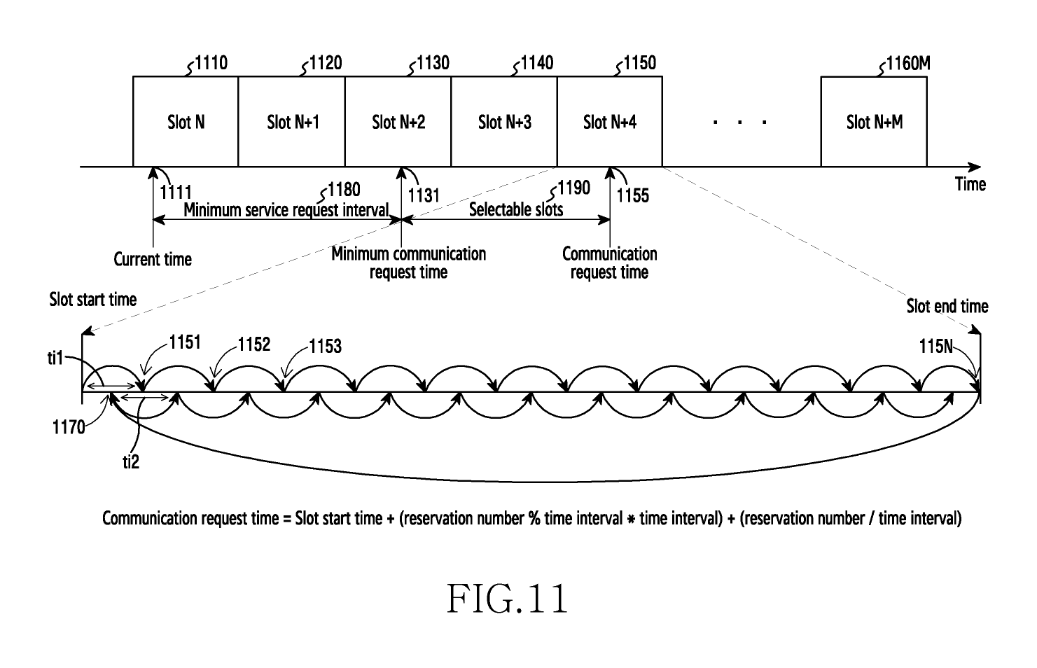

FIG. 11 illustrates an example of uniformly selecting slots according to various embodiments.

Referring to FIG. 11, the server (e.g., the processor 120) may divide time into a plurality of slots 1110 to 1160M. For example, the server may divide time into Slot N (1110), Slot N+1 (1120), Slot N+2 (1130), Slot N+3 (1140), Slot N+4 (1150), . . . , and Slot N+M (1160M). The server may receive a service request from the electronic device at the current time 1111 of Slot N (1110). The server may select a slot after the minimum service request interval 1180 from the current time 1111. For example, selectable slots 1190 may include at least one of Slot N+2 (1130), Slot N+3 (1140), or Slots N+4 (1150). The server may select Slot N+2 (1130), and may determine the communication request time 1131 based on the availability number or the reservation number of Slot N+2 (1130). Alternatively, the server may select Slot N+4 (1150), and may determine the communication request time 1155 based on the availability number or the reservation number of Slot N+4 (1150).

According to various embodiments, the server may divide Slot N+4 (1150) into a plurality of small time units based on the start time and the end time of Slot N+4 (1150). For example, the server may evenly or unevenly divide the time between the start time and the end time of Slot N+4 (1150). The server may divide the time between the start time and the end time of Slot N+4 (1150) by the first time interval (ti1), and may determine whether or not a service request has been reserved at each time interval point 1151, 1152, 1153, or 1155. The server may sequentially retrieve the reservation or non-reservation of the divided time interval points, and may determine, as the communication request time 1155, the time (e.g., 1155) that has not been reserved.

If all of the time interval points, which are obtained by dividing Slot N+4 (1150) by the first time interval (ti1), have been reserved with service requests, the server may divide the time from the point of time 1170 after a constant time from the start time of Slot N+4 (1150) by the second time interval (ti2), and may determine whether or not service requests have been reserved at the divided time interval points. According to various embodiments, the server may divide time by the second time interval (ti2) that is the same as the first time interval (e.g., ti1), or may divide time by the second time interval (ti2) that is different from the first time interval (e.g., ti1).

According to various embodiments, the server may determine the communication request time in various manners such that the reservation time points do not overlap each other in the slot.

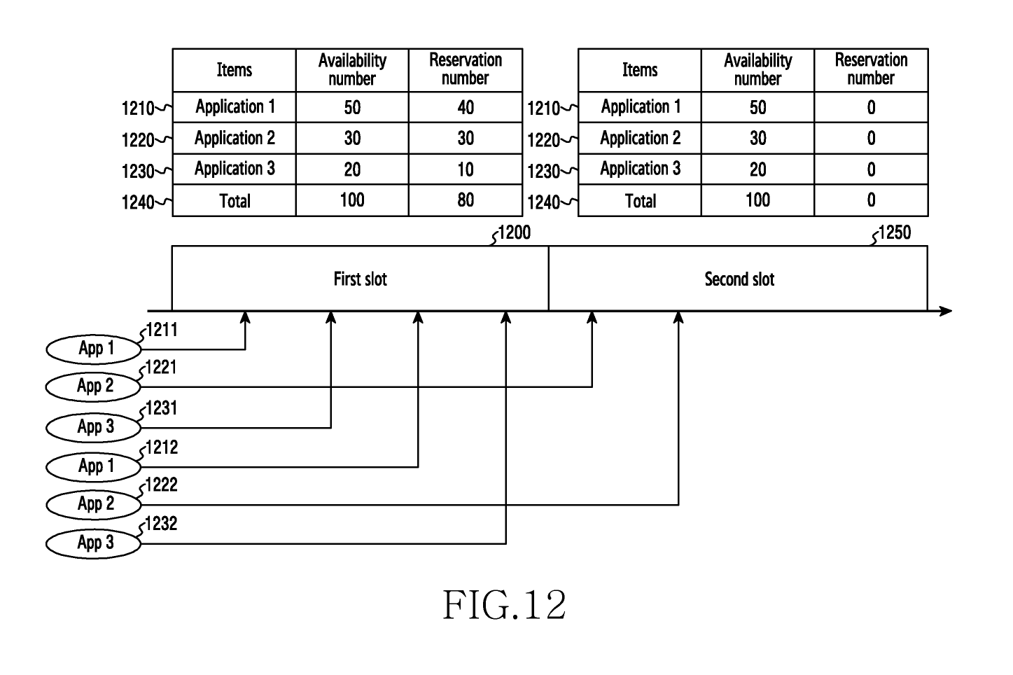

FIG. 12 illustrates an example of selecting a slot based on the priority according to various embodiments.

Referring to FIG. 12, the server (e.g., the processor 120) may differently allocate the availability number of a single slot depending on the priority. For example, the first slot 1200 may have the availability number of 100 in total. With respect to the first slot 1200, the server may allocate availability numbers of 50, 30, and 20 to the first priority 1210, the second priority 1220, and the third priority 1230, respectively. In addition, the second slot 1250 may have the availability number of 100 in total. With respect to the second slot 1250, the server may allocate availability numbers of 50, 30, and 20 to the first application 1210, the second application 1220, and the third application 1230, respectively.

In the drawing, the availability number is illustrated to be allocated to each application for understanding. That is, the first application 1210 may correspond to the first priority, and the second application 1220 and the third application 1230 may correspond to the second priority and the third priority, respectively. However, one priority may correspond to one or more applications. According to various embodiments, the availability numbers of a plurality of slots may be the same or different. Alternatively, the availability numbers for the priorities of the slot may be the same or different.

The time reservation database of the server may store the availability number or the reservation number for each slot, or the availability number or the reservation number for each application in a single slot. For example, the time reservation database may store the sum total 1240 of the availability numbers (i.e., 100) and of the reservation numbers (i.e., 80) in the first slot 1200. More specifically, the time reservation database may store the availability number (50) and the reservation number (40) for the first application 1210, the availability number (30) and the reservation number (30) for the second application 1220, and the availability number (20) and the reservation number (10) for the third application 1230 in the first slot 1200. In addition, the time reservation database may store the sum total 1240 of the availability numbers (i.e., 100) and of the reservation numbers (i.e., 0) in the second slot 1250. The time reservation database may store the availability number (50) and the reservation number (0) for the first application 1210, the availability number (30) and the reservation number (0) for the second application 1220, and the availability number (20) and the reservation number (0) for the third application 1230 in the second slot 1250.

In this case, when a service request is received from the electronic device, the server may select the first slot 1200 as a slot after the minimum communication request time interval. The server may identify the priority of the service information in the first slot 1200, and if the identified priority corresponds to the first application 1210, the server may retrieve the availability number or reservation number of the first application 1210 in the first slot 1200. If the availability number of the first application 1210 is 50 and the reservation number thereof is 40 in the first slot 1200, the server may determine, as the communication request time (e.g., 1211 or 1212), a certain point of time in the first slot 1200 because the reservation number (40) is equal to, or less than the availability number (50).

Alternatively, when a service request is received from the electronic device, the server may select the first slot 1200 as a slot after the minimum communication request time interval. The server may identify the priority of the service information in the first slot 1200, and if the identified priority corresponds to the second application 1220, the server may retrieve the availability number or reservation number of the second application 1220 in the first slot 1200. If the availability number of the second application 1220 is 30 and the reservation number thereof is 30 in the first slot 1200, the server may select another slot because the reservation number (30) is equal to the availability number (30). The server may select the second slot 1250 as another slot. The server may retrieve the availability number or reservation number of the second application 1220 in the second slot 1250. If the availability number of the second application 1220 is 30 and the reservation number thereof is 0 in the second slot 1250, the server may determine, as the communication request time (e.g., 1221 or 1222), a certain point of time in the second slot 1250 because the reservation number (0) is equal to, or less than the availability number (30).

Alternatively, when a service request is received from the electronic device, the server may select the first slot 1200 as a slot after the minimum communication request time interval. The server may identify the priority of the service information in the first slot 1200, and if the identified priority corresponds to the third application 1230, the server may retrieve the availability number or reservation number of the third application 1230 in the first slot 1200. If the availability number of the third application 1230 is 20 and the reservation number thereof is 10 in the first slot 1200, the server may determine, as the communication request time (e.g., 1231 or 1232), a certain point of time in the first slot 1200 because the reservation number (10) is equal to, or less than the availability number (20).

According to various embodiments, the server may perform various priority applying methods with respect to the time reservation of the service request. For example, with regard to the availability number and reservation number in a single slot, the percentage of the availability number may be determined for each priority with respect to n applications. The sum of priority percentages of the applications may be equal to, or less than, 100. For example, the availability number of the nth application may be calculated by multiplying the availability number of the slot by the nth priority percentage. The server may sort the n applications in the order of high priority, and the sequence of the sorted applications (e.g., the 101st application out of 1000 applications in total) may be the priority percentage. In addition, the reservation number of the nth application may be equal to, or less than, the availability number of the nth application. Therefore, the reservation number of the slot may be equal to, or less than, the reservation numbers of the n applications.

According to various embodiments, the server may variably adjust the availability number for each priority in the slot. For example, the server may calculate a response speed for each service (e.g., the application) in the service operation. The response speed may refer to the speed at which a response to the service request is processed. If the response speed decreases below a reference value, the server may dynamically increase the availability number of the service of which the response speed is decreasing, and may adjust, to near zero, the availability number of a service of which the response speed does not decrease. For example, if the response speed with respect to the second application 1220 decreases, the server may change: the availability number of the second application 1220 into 50; the availability number of the first application 1210 into 40; and the availability number of the third application 1230 into 10. In this case, the operation of problematic applications may be limited without a change in the physical server or in the server instance layer.

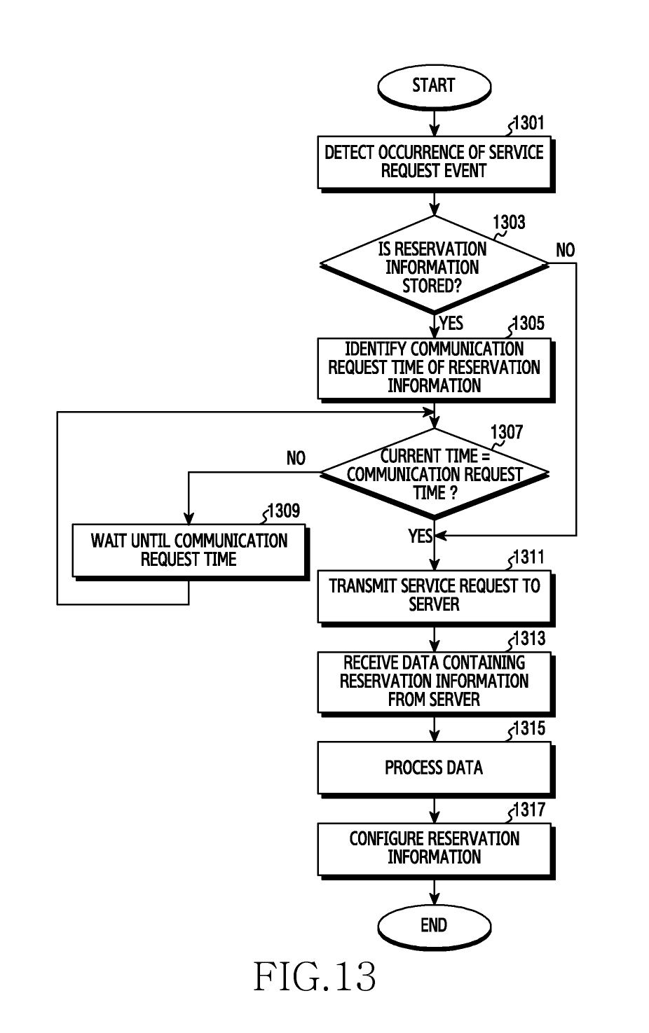

FIG. 13 illustrates a flowchart of an update processing method according to various embodiments.

Referring to FIG. 13, in operation 1301, the electronic device (e.g., the processor 120) may detect the occurrence of a service request event. For example, the service request event may include at least one of booting, connecting to the wireless Internet, the type of application, the priority of an application, the user configuration, or the device configuration. For example, when power is applied to the electronic device to then be booted, the processor may detect that the service request event has occurred. Alternatively, when the electronic device is connected to the wireless Internet, the processor may detect that the service request event has occurred. Alternatively, in the case where the type of application is configured as requesting the update when connecting to the wireless Internet, the processor may detect that the service request event has occurred when the electronic device is connected to the wireless Internet. Alternatively, in the case where the user configuration or device configuration is configured as requesting the update when connecting to the wireless Internet, the processor may detect that the service request event has occurred when the electronic device is connected to the wireless Internet.

When the service request event has occurred, the processor (e.g., the first time reservation scheduling agent 511) may determine whether or not the reservation information is stored in the memory (e.g., the memory 130) in operation 1303. The reservation information may contain communication request time or server access information. If the reservation information is stored in the memory, the processor may perform operation 1305. Otherwise, the processor may perform operation 1311.

If the reservation information is stored in the memory, the processor (e.g., the first time reservation scheduling agent 511) may identify the communication request time of the reservation information in operation 1305. The communication request time may refer to the reservation time for requesting the next service, and may be transmitted from the server (e.g., the first server 820). The communication request time may be configured as a specific time (e.g., 9:00 am) or in a certain period (e.g., a predetermined time every day or every week).

In operation 1307, the processor (e.g., the first time reservation scheduling agent 511) may determine whether or not the communication request time matches the current time. If the communication request time matches the current time, the processor may perform operation 1311, whereas if the communication request time does not match the current time, the processor may perform operation 1309.

When the communication request time does not match the current time, the processor (e.g., the first time reservation scheduling agent 511) may wait until the communication request time in operation 1309. The communication request time may be configured and transmitted by the server in order to disperse the load of the server, and the processor may wait until the communication request time to then request the service. Exceptionally, the processor may transmit a service request to the server without waiting until the communication request time depending on the user configuration or device configuration.

In operation 1311, the processor (e.g., the first time reservation scheduling agent 511) may transmit the service request (e.g., the update request) to the server through the communication interface 170. The service request may contain service information and device information. The service information may contain at least one of a version, the type, or an identifier of the firmware or application that is to be updated. The device information may contain at least one of an identifier of the electronic device, a user ID, or the phone number of the electronic device. If server access information is contained in the reservation information that is stored in the memory, the processor may determine the server to which the service request is transmitted by using the server access information. For example, if the server access information relates to the second server (e.g., second server 830), the processor may transmit the service request to the second server.

In operation 1313, the processor (e.g., the first time reservation scheduling agent 511) may receive the data containing the reservation information from the server through the communication interface 170. The communication interface 170 may receive the data from the server, and may forward the received data to the processor.

In operation 1315, the processor may process the received data. For example, the processor may update the application with the latest version 2.1.4 by using the update data. Alternatively, in the case of an application related to the weather, the processor may update the application with the weather information corresponding to the current date (e.g., the date required for the update) by using the update data. The processor may update the weather information of the area corresponding to the current location, as well as the current date, according to the configuration.

In operation 1317, the processor (e.g., the first time reservation scheduling agent 511) may configure the reservation information. The processor may update the reservation information that is stored in the memory. That is, the processor may delete the original reservation information that has been stored in the storage unit, and may store the reservation information that has recently been received.

A service processing method of an electronic device, according to various embodiments, may include: receiving a service request from at least one of a plurality of external devices; determining the communication request time that is related to the service request based on the reservation time stored in a memory and the load that is related to the reservation time; and transmitting the communication request time to at least one external device.

The determining may include: retrieving the availability number or the reservation number of the reservation time, which is stored in the memory of the electronic device; and determining the load of the communication request time based on the retrieved availability number and reservation number.

The determining may include determining, as the communication request time, the time that satisfies a predetermined condition among the reservation time for performing communication with a plurality of external devices.

The determining may include determining, as the communication request time, the time to process a work that is less than a reference value.

The determining may include: selecting a slot after the minimum service request interval among one or more slots obtained by dividing time; and determining the communication request time in the selected slot.

The determining may include: determining whether or not the reservation number of the selected slot is equal to, or less than, the availability number; and determining the communication request time in the selected slot if the reservation number is less than the availability number.

The determining may include: determining whether or not the reservation number of the selected slot is less than the availability number; selecting another slot if the reservation number is equal to the availability number; and determining the communication request time in another selected slot.

The determining may include: selecting a slot after the minimum service request interval among one or more slots obtained by dividing time; identifying the priority of service information that is contained in the service request in the selected slot; and determining the communication request time in the selected slot based on the availability number and the reservation number corresponding to the priority.

The determining may include: determining whether or not the reservation number corresponding to the priority is equal to, or less than, the availability number; and determining the communication request time in the selected slot if the reservation number is less than the availability number.

The determining may include: determining whether or not the reservation number corresponding to the priority is less than the availability number; selecting another slot if the reservation number is equal to the availability number; identifying the priority of service information contained in the service request in another slot that has been selected; and determining the communication request time in another slot based on the availability number and the reservation number corresponding to the priority.

A computer-readable recording medium, according to various embodiments, may include a program to execute the operations of: receiving a service request from at least one of a plurality of external devices; determining the communication request time that is related to the service request based on the reservation time stored in a memory and the load that is related to the reservation time; and transmitting the communication request time to at least one external device.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

Any of the modules or programming modules according to various embodiments of the present disclosure may include at least one of the above described elements, exclude some of the elements, or further include other additional elements. The operations performed by the modules, programming module, or other elements according to various embodiments of the present disclosure may be executed in a sequential, parallel, repetitive, or heuristic manner. Further, some operations may be executed according to another order or may be omitted, or other operations may be added.

Various embodiments disclosed herein are provided merely to easily describe technical details of the present disclosure and to help the understanding of the present disclosure, and are not intended to limit the scope of the present disclosure. Therefore, it should be construed that all modifications and changes or modified and changed forms based on the technical idea of the present disclosure fall within the scope of the present disclosure.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
a communication interface;
a memory configured to store a reservation time to perform communication with a plurality of external devices; and
a processor functionally connected to the communication interface and the memory, the processor is configured to:
receive a service request from at least one external device from the plurality of external devices through the communication interface;
determine a communication request time that is related to the service request based on the reservation time stored in the memory and a load related to the reservation time; and
transmit the determined communication request time to the at least one external device through the communication interface.

2. The electronic device according to claim 1, wherein the processor is configured to:
identify the communication request time based on the service request; and
determine the communication request time based on the reservation time to perform communication with the plurality of external devices and the load of the processor at the reservation time.

3. The electronic device according to claim 1, wherein the processor is configured to determine, as the communication request time, a time that satisfies a predetermined condition among the reservation time to perform communication with the plurality of external devices.

4. The electronic device according to claim 1, wherein the processor is configured to determine, as the communication request time, a time to process a work that is less than a reference value among the load related to the processor.

5. The electronic device according to claim 1, wherein the processor is configured to select the communication request time based on service information and device information included in the service request.

6. The electronic device according to claim 1, wherein the processor is configured to select the communication request time based on an availability number or a reservation number of the reservation time.

7. The electronic device according to claim 1, wherein the processor is configured to:
determine whether or not to apply a priority based on service information contained in the service request; and
select a slot based on the determination result.

8. The electronic device according to claim 1, wherein the processor is configured to:
divide time into a plurality of slots;
select a slot after the minimum service request interval among the plurality of slots; and
determine the communication request time in the selected slot.

9. The electronic device according to claim 8, wherein the processor is configured to:
determine whether or not a reservation number of the selected slot is equal to, or less than, an availability number; and
determine the communication request time in the selected slot if the reservation number is less than the availability number.

10. The electronic device according to claim 8, wherein the processor is configured to:
determine whether or not a reservation number of the selected slot is less than an availability number;
select another slot if the reservation number is equal to the availability number; and
determine the communication request time in another slot that has been selected.

11. The electronic device according to claim 1, wherein the processor is configured to:
divide time into a plurality of slots;
select a slot after the minimum service request interval among the plurality of slots;
identify a priority of service information that is contained in the service request in the selected slot; and
determine the communication request time in the selected slot based on an availability number or reservation number corresponding to a priority.

12. The electronic device according to claim 11, wherein the processor is configured to:
determine the reservation number corresponding to the priority is equal to, or less than, the availability number; and
determine the communication request time in the selected slot if the reservation number is less than the availability number.

13. The electronic device according to claim 11, wherein the processor is configured to:
determine whether or not the reservation number corresponding to the priority is less than the availability number;
select another slot if the reservation number is equal to the availability number;
identify the priority of service information that is contained in the service request in another slot that has been selected; and
determine the communication request time in another slot based on the availability number or reservation number corresponding to the priority.

14. An electronic device comprising:
a memory configured to store reservation information that is related to a service request; and
a processor functionally connected to the memory, the processor is configured to:
determine whether or not the reservation information is stored in the memory according to a detection of a service request event; and
transmit the service request to an external device at a communication request time contained in the reservation information or at a detection time of the service request event based on the determination result.

15. The electronic device according to claim 14, wherein the processor is configured to:
compare a current time with the communication request time contained in the reservation information if the reservation information is stored in the memory; and
transmit the service request if the current time matches the communication request time.

16. The electronic device according to claim 14, wherein the processor is configured to transmit the service request at the detection time of the service request event if the reservation information is not stored in the memory.

17. A service processing method comprising:
receiving a service request from at least one of a plurality of external devices;
determining a communication request time that is related to the service request based on a reservation time stored in a memory and a load related to the reservation time; and
transmitting the communication request time to at least one external device.

18. The method according to claim 17, wherein the determining comprises determining, as the communication request time related to the service request, a time to process a work that is less than a reference value among the load of a processor.

19. The method according to claim 17, wherein the determining comprises:
selecting, among a plurality of slots obtained by dividing time, a slot after the minimum service request interval;
determining whether or not the reservation number of the selected slot is equal to, or less than, an availability number; and
determining the communication request time in the selected slot if the reservation number is less than the availability number.

20. The method according to claim 19, wherein the determining comprises:
selecting another slot if the reservation number is equal to the availability number; and
determining the communication request time in another slot that has been selected.
